(19) United States
(12) Patent Application Publication
(10) Pub. No.: US 2008/0270163 A1
(43) Pub. Date: Oct. 30, 2008

(54) SYSTEM, PROGRAM AND METHOD FOR EXPERIENTIALLY INDUCING USER ACTIVITY

(76) Inventor: Jermon D. GREEN, (US)

Correspondence Address: MCGUIREWOODS, LLP, 1750 TYSONS BLVD, SUITE 1800, MCLEAN, VA, 22102, US

(21) Appl. No.: 11/960,020

(22) Filed: Dec. 19, 2007

Related U.S. Application Data
(60) Provisional application No. 60/877,022, filed on Dec. 26, 2006.

(51) Int. Cl. G06Q 99/00

(52) U.S. Cl. 705/1

(57) ABSTRACT

A unified experiential multimedia inducement and entertainment system, computer program and method for providing broadcasts of multimedia content from a plurality of providers to one or more users. The system, computer program and method provide for experience-based entertainment and inducement to individual users over one or more diverse communications medium, inducing the users to visit, frequent, or stay longer at a provider's physical or virtual location.

### CROSS REFERENCES TO RELATED APPLICATIONS

The present application claims the benefit of U.S. Provisional Patent Application No. 60/877,022, filed Dec. 26, 2006, which is hereby incorporated by reference in its entirety.

### FIELD OF THE DISCLOSURE

The present disclosure relates to a system, computer program and method for inducing user activities, such as, for example, increasing sales, increasing or enhancing brand awareness, increasing user loyalty and increasing brand reach while simultaneously providing an entertaining experience. More particularly, the present disclosure relates to a system, computer program and method for experientially inducing one or more user activities, such as, for example, visiting a provider's physical location and/or a virtual location.

### BACKGROUND INFORMATION

Currently, many product providers and service providers (hereafter referred to as “providers”) of all sizes and types are competing with electronic commerce (E-commerce) in a losing battle. A large part of the losses suffered by the providers may be attributed to the convenience of E-commerce, as well as discounts that may be readily searched and retrieved by users, such as, for example, prospects, shoppers, clients, customers, patrons, purchasers, buyers, frequenters, attendees, vendees, or the like. However, many other providers are embracing E-commerce as an integral part of doing business.

For example, many providers require a user to visit a provider's location in order to shop for goods and/or services. Once at the location, the user may pick up products or receive services. However, the user may find the provider's location to be inconveniently located. Moreover, the user may experience frustration due to, for example, delays at checkout, sometimes resulting in the user abandoning a product and/or service and walking out of the provider's location without purchasing the product and/or service. This causes a loss of revenue to the provider.

Cognizant of the above loss of revenue, certain providers have proposed on-location promotional and advertising systems that provide content or information to a user at a point of sale or service. For example, some providers sponsor programs such as “Checkout Coupon” and “Checkout Direct” to deliver coupons or other incentives to a point of sale or service, sometimes targeting the delivery to a particular user. Some of the same providers also sponsor, for example, an on-location instant-win game to give users incentives to shop at provider-locations where the game is made available. However, these programs provide little to relieve boredom that a user may experience while participating in the programs.

An unfulfilled need exists for an experiential system and/or method for inducing user activities, such as, for example, visiting a provider's location while simultaneously providing an entertaining experience. More particularly, an unfulfilled need exists to induce one or more user activities, such as, for example, frequenting a particular provider's physical and/or virtual location more often and staying longer at the location.

Additionally, an unfulfilled need exists for an experiential system and method for creating an opportunity for directly marketing to particular users while providing entertainment.

### SUMMARY OF THE DISCLOSURE

According to an aspect of the disclosure, a system is provided for a priori providing a user profile of a partaker user to a provider where the partaker user is scheduled to visit a location of the provider. The system may comprise a receiver configured to receive a multimedia content from the provider, a determiner configured to determine a chit set corresponding to the multimedia content or the provider, an aggregator configured to combine the multimedia content and the chit set to generate a streaming content, a user communicator configured to send the streaming content to the partaker user, a profiler configured to determine a chit on a basis of the chit selection and a user profile associated with the partaker user and a provider communicator configured to send a visit schedule message to the provider. The communicator may be further configured to receive a chit selection from the partaker user;

The system may further comprise a group assembler configured to receive user data from at least one user responding to a user solicitation event and generate a user group, including the user data, and a selector configured to select the partaker user from the user group on a basis of the user profile. The multimedia content may comprise at least one of a video content, an audio content, a text content and a control content. The aggregator may be further configured to link the chit set to a portion of the video content, where the link may be selectable by the user while sensing the streaming content to generate the chit selection. The multimedia content may further comprise a chit event and the chit event may comprise a live broadcast from the location of the provider. The provider communicator may be further configured to send the visit schedule message to another provider where the other provider may be located en route from a location of the partaker user to the location of the provider.

Further, the user communicator may be configured to send a chit event schedule to the partaker user. The visit schedule message, according to an aspect of the disclosure, may comprise at least one of a title of a live broadcast event, a name of the partaker user, a location of the partaker user, a route to be traveled by the partaker user, a date and time of the chit event, a telephone number of the partaker user, the chit selection of the partaker user, or the user profile of the partaker user.

According to a further aspect of the disclosure, the system may further comprise a mobile transducer system. The mobile transducer system may comprise an image pickup device configured to capture an image of an object, a transducer configured to sense an ambient signal, a display configured to display a message, an input-output interface configured to receive data from the user and a driver configured to move the mobile transducer system on the basis of a control signal. The driver may receive the control signal from one of a manual control input or a robot control input.

Furthermore, the mobile transducer system may generate the multimedia content. The mobile transducer system may further comprise a transducer configured to capture an image or a sound generated proximate to the partaker user and an input configured to receive data.

According to a further aspect of the disclosure, a method is provided for a priori providing a user profile of a partaker user to a provider where the partaker user is scheduled to visit a location of the provider. The method may comprise receiving a multimedia content from the provider, determining a chit set corresponding to the multimedia content or the provider, combining the multimedia content and the chit set to generate a streaming content, sending the streaming content to the partaker user, receiving a chit selection from the partaker user, determining a chit on a basis of the chit selection and a user profile associated with the partaker user and sending a visit schedule message to the provider. The method may further comprise receiving user data from at least one user responding to a user solicitation event to generate a user group, including the user data and selecting the partaker user from the user group on a basis of the user profile. The multimedia content may comprise at least one of a video content, an audio content, a text content and a control content. The combining may comprise linking the chit set to a portion of the video content, where the linking may be selectable by the user while sensing the streaming content to generate the chit selection. Moreover, the multimedia content may further comprise a chit event and the chit event may comprise a live broadcast from the location of the provider.

Further, the method may comprise sending the visit schedule message to another provider and sending a chit event schedule to the partaker user. The other provider may be located en route from a location of the partaker user to the location of the provider. The visit schedule message may comprise at least one of a title of a live broadcast event, a date and time of the chit event, a name of the partaker user, a location of the partaker user, a route to be traveled by the partaker user, a telephone number of the partaker user, the chit selection of the partaker user or the user profile of the partaker user. The multimedia content may be generated by a mobile transducer system.

The method may further comprise receiving a request from the provider for delivery of the mobile transducer system, determining a condition for use of the mobile transducer system by the provider and delivering the mobile transducer system to the provider. The mobile transducer system may comprise a transducer configured to capture an image or a sound generated proximate to the partaker user and an input configured to receive data.

According to a further aspect of the disclosure, a computer readable medium is provided. The computer readable medium comprises a program that when executed, causes a computer to a priori provide a user profile of a partaker user to a provider where the partaker user is scheduled to visit a location of the provider. The computer readable medium may comprise a receiver code section configured to cause, when executed, receiving a multimedia content from the provider, a determiner code section configured to cause, when executed, determining a chit set corresponding to the multimedia content or the provider, an aggregator code section configured to cause, when executed, combining the multimedia content and the chit set to generate a streaming content, a user communicator code section configured to cause, when executed, sending the streaming content to the partaker user, the communication being further configured to receive a chit selection from the partaker user, a profiler code section configured to cause, when executed, determining a chit on a basis of the chit selection and a user profile associated with the partaker user and a provider communicator code section configured to cause, when executed, sending a visit schedule message to the provider. The computer readable medium may further comprise a group assembler code section configured to cause, when executed, receiving user data from at least one user responding to a user solicitation event and generate a user group, including the user data and a selector code section configured to cause, when executed, selecting the partaker user from the user group on a basis of the user profile.

### BRIEF DESCRIPTION OF THE DRAWINGS

The present disclosure is further described in the detailed description that follows, by reference to the noted drawings by way of non-limiting examples of embodiments of the present disclosure, in which like reference numerals represent similar parts throughout the several views of the drawings:

FIG. 1 illustrates an exemplary embodiment of an experiential system (E-system) according to an aspect of the disclosure;

FIG. 2 illustrates an exemplary embodiment of a mobile transducer system (MTS) according to an aspect of the disclosure;

FIG. 3 illustrates a flow diagram of an exemplary E-system process according to an aspect of the disclosure;

FIG. 4 illustrates an exemplary process for promoting chits according to an aspect of the disclosure;

FIG. 5 illustrates an exemplary embodiment of a user process for accessing the E-system according to an aspect of the disclosure;

FIG. 6 illustrates an exemplary flow diagram of a process for generating a user display screen(s) according to an aspect of the disclosure;

FIG. 7 illustrates an exemplary embodiment of a computer that may be provided at a provider location according to an aspect of the disclosure;

FIG. 8 illustrates an exemplary option display which a user may view, according to an aspect of the disclosure;

FIG. 9 illustrates an exemplary non-limiting embodiment of a computer that may be provided in the E-Aggregator system according to an aspect of the disclosure;

FIG. 10 illustrates an exemplary non-limiting embodiment of a datacenter according to an aspect of the disclosure;

FIG. 11 illustrates an exemplary flow diagram showing different aspects of a process for direct marketing according to an aspect of the disclosure; and

FIG. 12 illustrates a flow diagram of an exemplary non-limiting process for awarding chits according to an aspect of the disclosure.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure.

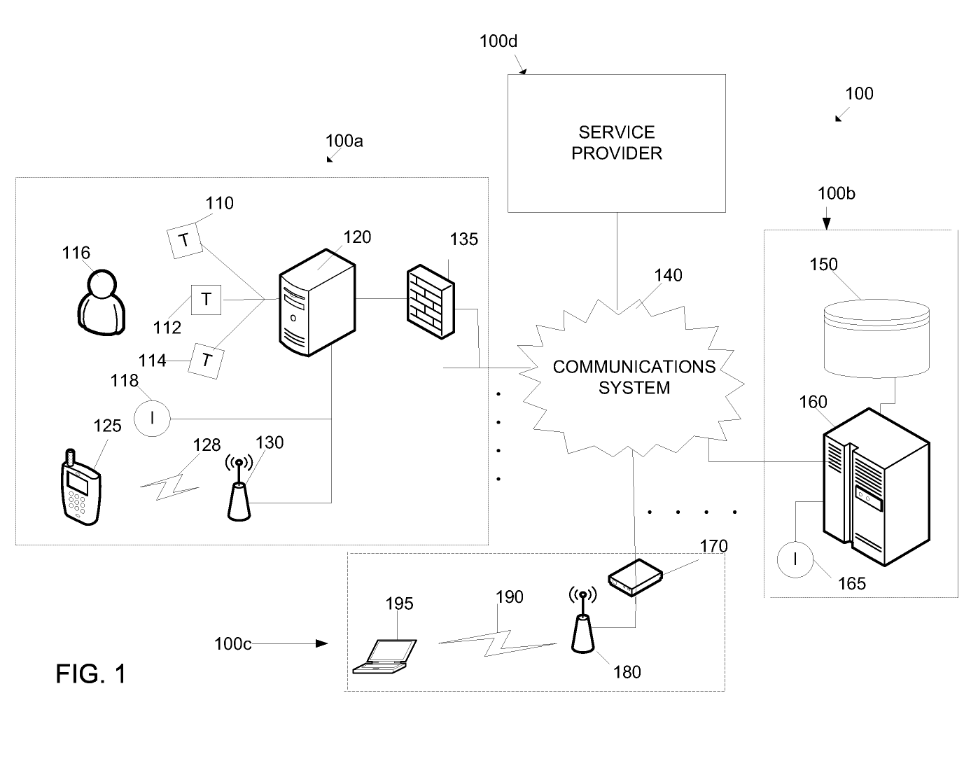

FIG. 1 shows an exemplary, non-limiting embodiment of an experiential system (E-system) 100 for inducing user activities, such as, for example, but not limited to, visiting a particular physical provider location or a virtual provider location, staying longer at the location and/or frequenting the location more often, according to an aspect of the disclosure. The E-system 100 may be configured to include at least five systems, including at least one provider system 100a, a communications system 140, an E-Aggregator system 100b, at least one user system 100c and at least one service provider system 100d.

According to a preferred embodiment of the disclosure, a plurality of provider systems 100a may be provided and coupled to the communications system 140. Each of the plurality of provider systems 100a may be provided at a different provider location. The different provider locations may include any one or more physical locations, such as, but not limited to, for example, a building, a room, a parking lot, a field, a retail store, a restaurant, a loft, a wholesale store, a night club, a sporting arena, a sporting event, and/or the like. The different provider locations may also include any one or more virtual locations, such as, but not limited to, for example, an access point address, a network address, a website address, a telephone number, an email address, a television channel, a television satellite channel, a radio channel, a radio satellite channel, and/or the like.

The one or more provider systems 100a may be coupled to the communications system 140 via a wired communication media, a wireless communication media, or a combination of a wired and a wireless communications medium, as is known in the relevant art.

Further, a plurality of user systems 100c may be coupled to the communications system 140. Each one of the plurality of user systems 100c may be provided at a different user location. A user location may include a physical location, such as, but not limited to, for example, a residence, a school, a workplace, a restaurant, a coffee shop, an airport, a bus terminal, a train station, or any other private or public location, including a provider location, or any combination of the preceding as will be readily appreciated by the skilled artisan, without departing from the scope and spirit of the disclosure. Additionally, the user location may include a virtual location, such as, but not limited to, for example, an access point address, a network address, a website address, a telephone number, an email address, a television channel, a television satellite channel, a radio channel, a radio satellite channel, or the like.

In FIG. 1, the provider system 100a may include one or more transducer devices 110, 112 and 114, a computer 120, an access point 130, one or more handheld computer devices 125 and an interface device 118. The E-Aggregator system 100b may include a server system 160, a database system 150 and an interface system 165. The user system 100c may include a communicator device 170 (such as, e.g., a modem, a router, a set-top box, an intelligent peripheral, or the like), an access point 180 and a user computer device 195. The service provider location 100d may include a cable television service provider, an Internet service provider, a television service provider, a radio service provider, a satellite radio service provider, a satellite television service provider, a mobile telephone service provider, and the like.

In the provider system 100a, one or more transducer devices 110, 112, 114 may be configured to capture a still image and/or a moving image of a subject 116, as well as an audio signal, and to output a multimedia content signal. At least one of the transducer devices 110, 112, 114 may be configured to sense an ambient signal such as, but not limited to, for example, an infrared signal, an x-ray signal, an electromagnetic signal, and the like, generated by an object or a person. The transducer devices 110, 112, 114 may include, but are not limited to, for example, video cameras, video surveillance cameras strategically affixed in the provider's physical location, still cameras, infrared cameras, biometric sensors, and the like. The subject 116 may be a person, an object, or a combination of a person and an object. The transducer devices 110, 112, 114 may be coupled to the computer 120 via a wireless, a wired, or a combination of a wireless and a wired communication medium to communicate the output multimedia content signals to the computer 120. The transducer devices 110, 112, 114 may also receive multimedia content signals and control signals from the computer 120.

In a preferred embodiment according to the disclosure, one or more of the transducer devices 110, 112, 114 are configured as video camera system. The video camera system may generally be constituted by conventional hardware arrangements for such devices, except that, for certain embodiments of the disclosure, it is desirable that the video camera system include a suitable display, such as a liquid crystal display (LCD) or other display device capable of displaying images, graphics, photographic images or the like. The video camera system may include two or more cameras, including one facing an event host and another facing one or more on-site users. It is preferred that the camera facing the one or more on-site users be properly labeled to avoid privacy issues.

For example, the camera may be labeled with a release notice such as, for example, the following:
The contracting party grants THE PROVIDER an unrestricted right to copyright, use and reproduce videos, sounds, and/or photographs of the contracting party for commercial, promotion, competition or other purposes without compensation or liability to the contracting party.

The computer 120 may be coupled to the communications system 140 via a firewall 135 to communicate with communication systems external to the provider system 100a, such as, but not limited to, for example, other provider systems 100a, the E-Aggregator system 100b, the service provider system 100d and/or the user system 100c. The firewall 135 may be configured to control the exchange of data between the provider system 100a and the communications system 140, as is known in the relevant art.

An interface device 118 may be coupled to the computer 120 to facilitate an exchange of data between the computer 120 and any one or more of a user (not shown), a host, and/or at least one peripheral device (not shown), such as, for example, a printer, a display, a sound generator, one or more buzzer buttons, a digital video disc player, an audio player, a game device, a special effects generator, and the like.

Although the provider system 100a is shown in FIG. 1 as communicating with any one of the systems 100b to 100d through the communications system 140, the provider system 100a may be configured to include a transceiver (not shown) for wirelessly communicating directly to another provider system 100a, the E-Aggregator system 100b, the user system 100c, or the service provider system 100d, via, for example, a WiFi communications link, a radio frequency communications link, a satellite communications link, an optical communications link, and the like.

The computer, 120 includes, but is not limited to, for example, an electronic device configured to accept data, perform prescribed mathematical and logical operations at high speed, and output the results of these operations. The computer 120 may include, but is not limited to, for example, one or more of a personal computer, a laptop computer, a palmtop computer, a notebook computer, a desktop computer, a workstation, a computer server, a mainframe computer, or the like.

The access point 130 may be coupled to the computer 120 via a wireless communication media, a wired communication media, or a combination of a wireless and a wired communication medium. The access point 130 facilitates communication between the computer 120 and the handheld computer device 125 via a wireless communication link 128. The wireless communication link 128 may include, for example, at least one of an IEEE 802.11 standard-compliant link, a DECT standard-compliant link, an 0G, 1G, 2G, 3G or 4G cellular standard-compliant link, a Bluetooth compliant link, or the like.

The handheld computer device 125 may include, but is not limited to, for example, a laptop computer, a palmtop computer, a notebook computer, a mobile telephone device, a personal data assistant, or the like, each of which may be configured to include an image pick up device (not shown), an audio pick up device (not shown), a biometric sensing device (not shown) and the like, or any combination thereof.

The communications system 140 may include, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), or the like, any of which may be configured to communicate data via a wireless and/or a wired communication media.

The E-Aggregator system 100b may include a server system 160, a database system 150 and an interface system 165. The server system 160 may include, but is not limited to, for example, any combination of software or hardware, as the skilled artisan will readily recognize, including at least one application and/or at least one computer to perform services for connected clients as part of a client-server architecture. The at least one server application may include, but is not limited to, for example, an application program that can accept connections to service requests from clients by sending back responses to the clients. The server system may be configured to run the at least one application, often under heavy workloads, unattended, for extended periods of time with minimal human direction. The server system may include a plurality of computers configured, with the at least one application being divided among the computers depending upon the workload. For example, under light loading, the at least one application can run on a single computer. However, under heavy loading, multiple computers may be required to run the at least one application. The server system, or any if its computers, may also be used as a workstation.

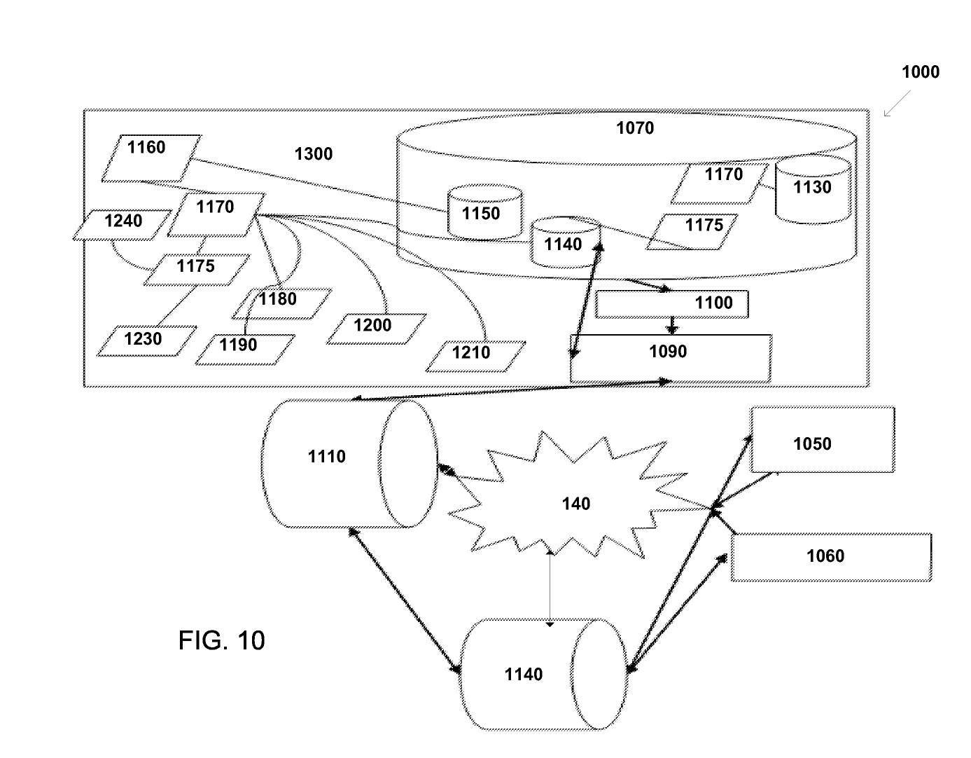

The database system 150 may include, for example, any combination of software or hardware configured to receive, store, manage, process and output data. The interface system 165 may be configured to receive data such as, for example, control data received from a user, and to output data such as, for example, display data to a user. Further, the database system 150 may include a data center as described later with reference to FIG. 10.

In the user system 100c, the communicator device 170 may be configured to connect to the communications system 140 via a wired, a wireless, or a combination of a wired and a wireless communications medium, as is known in the relevant art. The communicator device 170 may facilitate communication between the access point 180 and the communications system 140 using, for example, but not limited to, a cable television (CATV) communication media, a satellite communication media, a radio frequency communication media, an internet protocol such as a transmission control protocol (TCP) or a user datagram protocol (UDP) and the internet protocol (IP), and the like. The access point 180 may communicate with the computer device 195 via a wireless, a wired, or a combination of a wireless and a wired communication link 190. The communication link 190 may include, for example, at least one of an IEEE 802.11 standard-compliant link, a DECT standard-compliant link, an 0G, 1G, 2G, 3G or 4G cellular standard-compliant link, a Bluetooth compliant link, or the like.

Alternatively, the computer device 195 may be coupled directly to the communications system 140 through, for example, a WiFi communications link, a household wire link, an Ethernet link, a broadband network link, or the like.

Further, the computer device 195 may include, but is not limited to, for example, an electronic device configured to accept data, perform prescribed mathematical and logical operations at high speed on the data, and output the results of these operations. The computer device 195 may further include, for example, a personal computer, a laptop computer, a palmtop computer, a notebook computer, a desktop computer, a workstation, a television receiver set, a telephone device, a mobile telephone device, a radio receiver, a satellite radio receiver, or the like.

According to an aspect of the disclosure, the transducer devices 110, 112, 114 may be provided at a provider's physical location. The computer 120 may be similarly provided at the provider's location. Alternatively, the computer 120 may be provided at some other location remote from the provider's physical location.

Further, according to a preferred embodiment of the disclosure, the computer 120 may be synchronized with the server system 160 of the E-Aggregator system 100b by, for example, one of the computer 120 and the server system 160 first connecting to the communications system 140 and then forming a virtual private network (VPN) connection using, for example, tunneling with the other one of the computer 120 and the server system 160. Resultantly, data may be securely exchanged between the provider system 100a and the E-Aggregator system 100b and, in particular, the computer 120 and the server system 160. The data exchanged between the computer 120 and the server system 160 may be encrypted for additional security, i.e., in addition to encapsulation of data packets and tunneling of the encapsulated data packets.

According to a further aspect of the disclosure, a user may configure a user profile associated with the user to automatically bill a users cable television subscription account, credit card account, telephone account, provider account, and the like, or to automatically withdraw funds from a checking account, a savings account, a money-market account, and the like, for a purchased product or service. The transaction of the product or service purchase may be carried out via a mobile transducer system (MTS) located at a provider location as discussed below or remotely at the user system 100c. Moreover, the purchased product or service may be automatically scheduled for delivery and delivered to the user or some other predetermined location in accordance with one or more rules provided in the user profile.

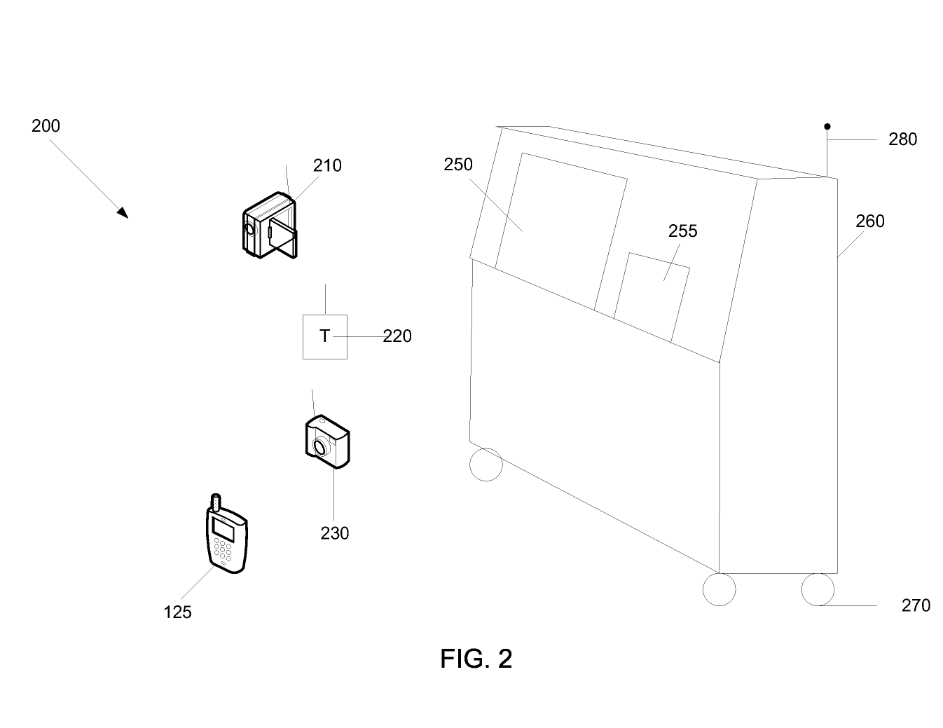

FIG. 2 illustrates an exemplary mobile transducer system (MTS) 200 according to a further aspect of the disclosure. The MTS 200 may be configured to be delivered to a provider location that, for example, may not have the necessary software and/or the necessary hardware to implement an aspect of the disclosure. Additionally, the MTS 200 may be rented, leased or sold to the provider location as an integral part of a subscription service or as a separate product. In this regard, delivery of the MTS 200 to the provider may be based on a condition such as, for example, a predetermined rental fee for the particular provider, a distance the MTS 200 must traverse to reach the provider, a length of use of the MTS 200 by the provider, and the like.

For example, the MTS 200 may include, but is not limited to, a portable kiosk system (PKS) 260, at least one movie camera 210, a transducer device 220, an image pickup device 230 and a handheld computer device 125, each of which may be coupled to the PKS via a wired, a wireless or a combination of a wired and a wireless communication media. The MTS 200 may be configured to be transported to a provider location, such as, for example, a retail store, a wholesale store, a motor vehicle parts dealer, a vehicle dealership, a furniture store, a home furnishings store, an electronics store, an appliance store, a building materials and supply store, a lawn and garden equipment store, a food and beverage store, a clothing and clothing accessories store, a sporting goods store, a hobby store, a musical instruments store, a book store, a periodical store, a music store, a toy store, a general merchandise store, an office supply store, a stationary store, a gift store, a restaurant, a sports arena, a field, a parking lot, a bar, a night club, a gambling facility, and the like. The PKS 260 may be delivered to the provider location using, for an example wheels 270 for enhanced mobility, and connecting the PKS 260 to a power source, a telephone jack, an Ethernet jack, or the like, any of which may be available at the provider's location.

Alternatively, the movie camera 210, the transducer device 220, the image pickup device 230 and the handheld computer device 125 may be integrally formed with the PKS 260 or attachable to the PKS 260 or some other structure (not shown)

The movie camera 210, the transducer device 220 and/or the image pickup device 230 may be configured to be controlled manually or automatically. For example, the movie camera 210 or the image pickup device 230 may be controlled to capture a moving image or still image of an object or person through manipulation of an interface device (not shown) such as, for example, a joy stick (not shown), a plurality of actuators (not shown) and a display 250. That is, the movie camera 210 or the image pickup device 230 may be maneuvered in the three-dimensional world coordinate system (x, y, z) through manipulation of the joy stick and/or actuators, causing the movie camera 210 or the image pickup device 230 to tilt up, tilt down, pan right, pan left, zoom-in, zoom-out, or any combination thereof. The transducer device 220 may be manipulated in a similar manner through manipulation of the interface device (not shown). The movement of the movie camera 210, the transducer device 220 or the image pickup device 230 may be facilitated using, for example, servo motors and controls.

Further the movie camera 210, the transducer device 220 and/or the image pickup device 230 may be controlled automatically as is known in the relevant arts. The movie camera 210 may be configured to respond to a particular sensory signal (such as, for example, a particular characteristic of a sound, an image, a visible light signal, a non-visible light signal, and the like), automatically moving in the x, y, z coordinate system to align its optical axis in the direction of the source of the sensory signal. For example, the movie camera 210 may automatically move to align its optical axis in the direction of a particular sound emanating from a user. The movie camera 210 may then focus in on the user to capture a clear moving image. The transducer device 220 and the image pickup device 230 may be controlled in a similar manner.

The PKS 260 may be configured to function autonomously by, for example, including a power supply (not shown) to provide power to all of the components of the MTS 200, a communications transceiver (not shown) to enable communication with a system and/or device located external to the PKS 260 and a drive system (not shown) to drive the wheels 270 manually under user control or automatically under remoter or robotic control.

Furthermore, the PKS 260 may be configured to include a computer (not shown, such as, e.g., computer 120 in FIG. 1), an input/output interface (not shown), the display 250, a peripheral device 255 (such as, e.g., a printer, a biometric device, a scanner, a user interface, and the like) and a secure compartment (not shown) for safely and securely storing the movie camera 210, the transducer device 220, the image pick up device 230 and the handheld computer device 125 when not in use. The PKS 260 may be further configured to provide video or sound editing using the computer (not shown) and the input/output interface (not shown).

The PKS 260 may include a wireless communication link 280 to provide either (or both) a Wi-Fi link (such as, for example, an IEEE 802.11 link) or a broadband communication link to the communications system 140, the E-Aggregator system 100b or the user system 100c (shown in FIG. 1). The wireless communication link 280 may also provide a wireless communication link (such as, e.g., a Wi-Fi link, an optical communication link, or the like) to each of the movie camera 210, the transducer device 220, the image pick up device 230 and the handheld computer device 125.

The transducer device 220 may be configured similar to any one of the transducer devices 110, 112, 114 shown in FIG. 1. The image pick up device 230 may be any type of image pick up device, including, but not limited to, for example, a digital still camera, a digital movie camera, a cellular telephone camera, or the like. Further, the movie camera 210 may be any image pick up device capable of capturing moving images and sounds and outputting a composite signal to the MTS 200.

Additionally, the MTS 200 may be configured as a virtual slot machine or an on-location user interface. In this regard, the MTS 200 may display on the display 250, for example, spinning “reels” of chits, which when matched in a predetermined pattern, result in a chit being awarded to a user, who may be on-location with the MTS 200 or remotely located at the user system 100c (shown in FIG. 1).

Further, the MTS 200 may be configured as an on-location user interface for receiving data from the user via the peripheral device 255 in response to messages provided to the user via the peripheral device 255 or the display 250. The messages provided to the user may include, for example, one or more predetermined questions provided as a part of an interactive chit solicitation event. The received data may include, for example, answers to the one or more questions, which, if the user answers correctly, may result in a chit being awarded to the user and reproduced by the peripheral device 255 on-location or reproduced at the user system 100c (shown in FIG. 1).

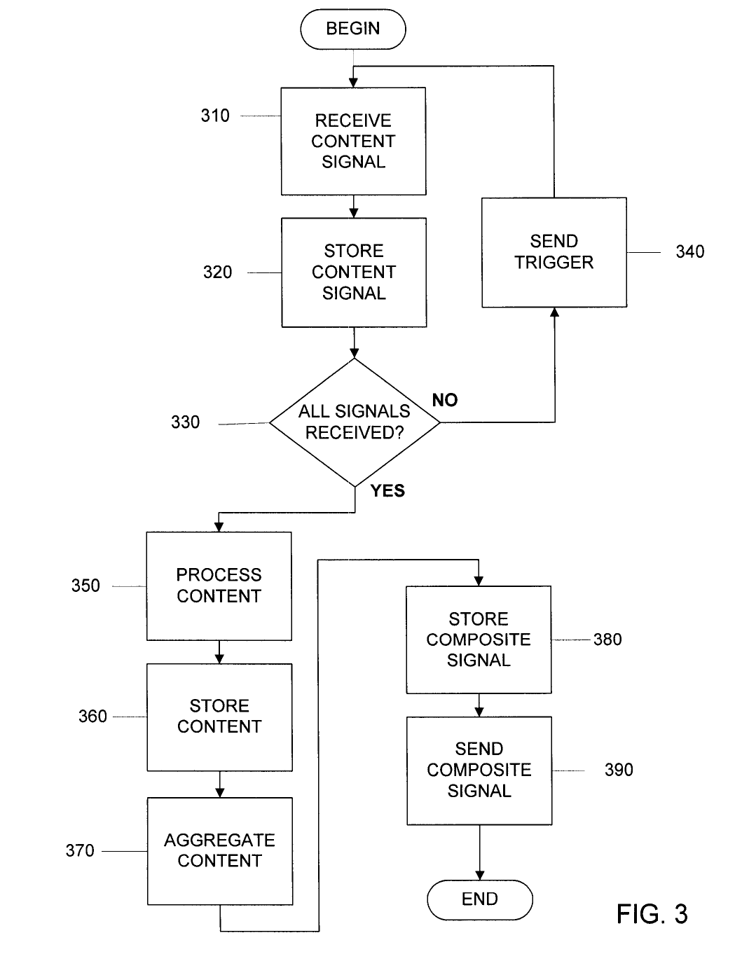

FIG. 3 illustrates a flow diagram of an exemplary, non-limiting E-system process according to an aspect of the disclosure. The exemplary E-system process may be carried out by, for example, the server system 160 located in the E-Aggregate system 100b (shown in FIG. 3).

Referring to FIG. 3, a multimedia content signal is initially received from a provider N (Step 310) at the server system 160, where N is a positive non-zero integer. The multimedia content signal may be received via the communications system 140 shown in FIG. 1. Additionally, the multimedia content signal may be received via a satellite communications link (not shown), or any other communications media as will become readily apparent to the skilled artisan depending on the application of the disclosure without departing from the scope and/or spirit of the disclosure. The received multimedia content signal is stored in the server system 160 (Step 320). The multimedia content signal may also be stored in the database system 150. The multimedia content signal may include at least one component signal, including, but not limited to, for example, a video signal, an audio signal, a textual signal, a control signal, a synchronization signal. The multimedia content signal may be stored in the server system 160 and/or database system 150 as a complete file or as one or more component signal files aggregateable to form the multimedia content signal.

A determination is made whether a multimedia content signal has been received from all of the providers scheduled to send a multimedia content signal at a predetermined time (Step 330). While shown as succeeding Step 320, the determination of Step 330 may be made prior to Step 320. The determination may be made by, for example, comparing a compiled list of providers from which multimedia content signals have been received to a table containing a group of providers that are scheduled to send multimedia content signals at the predetermined time. If a determination is made that a multimedia content signal has not been received from each of the providers in the group (“NO” at Step 330), then a trigger signal may be sent to those providers from which a multimedia content signal was not received (Step 340), and returning the E-system process to Step 310. The trigger signal may include, for example, a control signal instructing or reminding a provider to send a multimedia content signal to the E-Aggregator system 100b (shown in FIG. 1). The trigger signal may also include, for example, a broadcasting schedule for one or more user coverage areas, which may be selected based on, e.g., geographic factors such as, but not limited to, a zip code, an area code, a range of global positioning satellite (GPS) coordinates, a city, a county, a state, a province, a country, or the like.

If a determination is made that a multimedia content signal has been received from each of the providers in the group scheduled to send multimedia content signal at the predetermined time (“YES” at Step 330), then each of the received multimedia content signals may be processed (Step 350) and stored as a processed multimedia content signal (Step 360). The processing that may be performed (Step 350) may include, but is not limited to, for example, parsing, editing, deleting and/or augmenting a video portion, an audio portion, a textual portion, or a control portion of the received multimedia content signal.

The processed multimedia content signals are aggregated into at least one streaming composite signal (Step 370) and stored in the server system 160 and/or the database system 150 (Step 380). The at least one streaming composite signal may then be sent to the user system 100c, the service provider system 100d and/or another provider system 100a (Step 390). The multimedia content signals may be aggregated into the streaming composite signal by multiplexing the multimedia content signals in, but not limited to, a time domain using, for example, time-division-multiplexing (TDM) or a frequency domain using, for example, frequency-division-multiplexing (FDM).

In addition to being sent as at least one streaming composite signal, the streaming composite signal may be made available to the service provider system 100d and/or at least one user system 100c as a series of web pages and/or a streaming composite signal, each of which may be accessed via, for example, the Internet, In this regard, the streaming composite signal may be parsed and stored in the database system 150 so as to be searchable and retrievable by a provider, a service provider system, or a user, as is readily understood by the skilled artisan without departing from the scope and/or spirit of the disclosure.

According to an exemplary aspect of the disclosure, and in particular, the exemplary process shown in FIG. 3, a plurality of multimedia content signals (each multimedia content signal including, e.g., an image signal, an audio signal, a control signal, a synchronization signal or a textual signal) may be received in real time (e.g., live) from a plurality of respective providers and selectively combined to form one or more streaming composite signals. The streaming composite signals may then be broadcast via a radio frequency communications media (such as, e.g., a television signal communication media, a radio signal communication media, a cellular telephony communications media, and the like) or sent via the communications system 140 to one or more user systems 100c (shown in FIG. 1). For example, the streaming composite signals may be provided to one or more user systems 100c via one or more cable-television channels, radio channels, satellite radio channels, an Internet website, or the like.

According to a further aspect of the disclosure, a plurality of connections may be initialized between the server system 160 and a plurality of computers 120 located at different, respective provider locations. The server system 160 may be configured to simultaneously receive multiple multimedia content signals from respective multiple providers in real time.

According to a still further aspect of the disclosure, a computer program may be provided on a computer readable medium that, when executed, may cause a computer to carryout, for example, the exemplary E-system process described above and shown in FIG. 3. The computer readable medium may include a plurality of code sections, including a code section corresponding to each of the Steps 310 through 390 shown in FIG. 3.

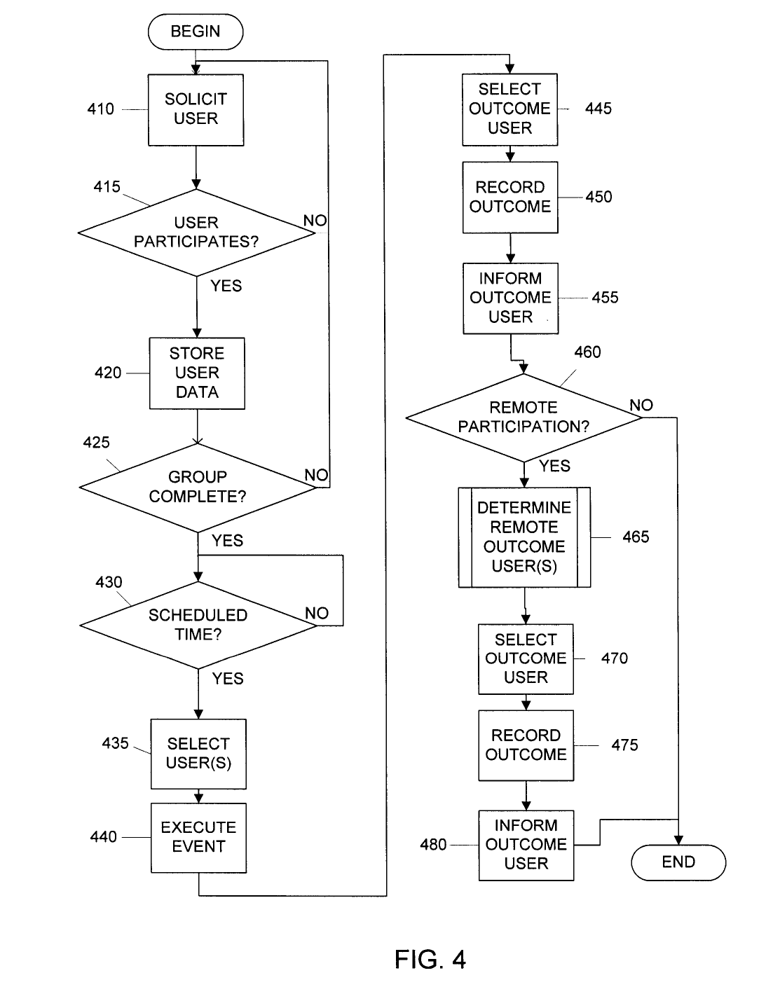

FIG. 4 illustrates an exemplary embodiment of a process for promoting chits according to an aspect of the disclosure. The chit promoting process may include, for example, a solicitation event that may be prescheduled or conducted spontaneously in real time at a provider location. Where the solicitation event is prescheduled, the schedule may be made available to users via a short message service (SMS) message, an email message, an instant broadcast message, a television signal message, a radio message, a satellite radio message, a provider location-based message (such as, e.g., a public announcement (PA) message, a poster, a flier, a banner, and the like), or the like, or any combination thereof.

The solicitation event may result in a user receiving a chit, such as, but not limited to, for example, a free product or service, a discount on a purchase of a product or service, an up sell, a coupon for a product or service, a voucher for a product or service, and the like. The resultant chit may be associated with a particular user or a particular group of users by, for example, referencing a unique identifier associated with the particular user and/or group of users. The unique identifier may include, but is not limited to, for example, a social security number, an account number, a credit card number, a telephone number, an email address, a street address, a building address, a website address, a name, an employee identification number, or any other identifying information capable of uniquely identifying a particular user or group of users, as understood by the skilled artisan depending on a particular application of the disclosure.

The chit may include, but is not limited to, for example, the particular user identifier, a pictorial representation of a physical provider location, a product or service identifier (e.g., a code that uniquely identifies the product or service), a price of the product or service, a value amount, a trademark or trade name of the provider, and the like.

Referring to FIG. 4, a user may receive notice of a solicitation event (Step 410). The notice may include information such as, for example, the provider's name, one or more provider locations, terms and conditions of the event, a scheduled time and location for the event, and the like. The notice may be provided in-person to the user by, for example, a host (e.g., a representative of the provider) or an on-location message such as, for example, a display sign or announcement. Additionally, the notice may be sent to the user as, for example, a short message service (SMS) message, an email message, a broadcast message, a television signal message, a radio message, a satellite radio message, a provider location-based message, or the like, or any combination thereof.

Having received the notice (Step 410), the user may be queried whether the user wishes to be included in a group (pool) of users interested in participating in the solicitation event (Step 415). If the user wishes to be included in the group of interested users (“YES” at Step 415), then user data may be collected from the user and stored in the server system 160 and/or database system 150 (Step 420), otherwise the process returns to Step 410 (“NO” at Step 415). The collected user data may include data such as, but not limited to, for example, a user's legal agreement authorizing the provider to use a captured image of the user, a recorded sound of the user, an image(s) of the user, a name, a telephone number, an address, a store account number, a credit card number, an employee number, a social security number, a badge identifier, an entry form, a photo entry, and the like.

Additionally, if the user is solicited (Step 410) and/or queried by a representative of the provider while on-location at a provider location (Step 420), then the user data may be collected from the user at the provider system 100a using, for example, one of the transducer devices 110, 112, 114, the handheld computer device 125 or the interface 118 (via, e.g., a display, a keyboard and mouse configuration) and stored in the computer 120. The collected data may then be sent to the E-aggregator system 100b by the computer 120 via the communications system 140.

Next, a determination may be made whether a predetermined group of users has been obtained (Step 425). Of course, if only a single user may participate in the solicitation event, this step (Step 425) may be omitted and the process may proceed to determining whether the present time is a prescheduled time (Step 430).

If it is determined that the predetermined group (pool) of users has been obtained (“YES” at Step 425), then a determination is made whether the present time is a prescheduled time (Step 430). If it is determined that the present time is the prescheduled time (“YES” at Step 430), then one or more users are selected from the group of users (Step 435), otherwise the process is held in standby until the prescheduled time (“NO” at Step 430).

The one or more users may be selected from the group of users at the beginning of the solicitation event by selecting the one or more users (e.g., the event participants) through a pre-determined process, as will be readily apparent to the skilled artisan, drawing from the group of users.

An event outcome user may be selected at the conclusion of the solicitation event (Step 445) and a result of the solicitation event may be associated with the user data and stored in the server system 160 and/or database system 150 for the event outcome user (Step 450). For example, the event outcome user may be a winning event participant who is determined on a basis of a pre-determined process, such as, for example, but not limited to, correctly answering a predetermined number of questions, performing one or more assigned tasks, or the like. In this regard, the result of the solicitation event (e.g. the outcome user has won the event) may be associated with the particular outcome user by, for example, creating one or more new entries in a record associated with the outcome user. The new entries may include data such as, but not limited to, for example, the name of the solicitation event, the date and time the event was executed, the name of the provider location at which the event was executed, the address of the provider location, the specific terms and/or conditions for the event, and the like.

After the result of the solicitation event have been associated and stored for the particular outcome user (Step 450) a message may be provided to the outcome user informing the user of the particular details of the result of the solicitation event, including, but not limited to, for example, a chit (e.g., a particular product and/or service the user may have won, a coupon for a particular product and/or service, a discount for a particular product and/or service) and particular ways in which the outcome user may obtain the chit (Step 455). The message may be provided to the outcome user as, for example, a spoken, Braille, or displayed message at the site of the event, a short message service (SMS) message, an email message, a broadcast message, a television signal message, a radio message, a satellite radio message, a provider location-based message, or the like, or any combination thereof.

Next, a determination may be made whether the scheduled solicitation event was available to remote users who are not at the provider location (Step 460). If it is determined that the solicitation event was available to remote users (“YES” at Step 460), then the chit promoting process determines one or more remote outcome users according to a predetermined process (Step 465), otherwise the process ends (“NO” at Step 460).

The one or more remote users may be determined from the group of users described above and/or from another group of users that includes a greater number of remote users. The determination process will be readily apparent to the skilled artisan based on the particular application of the disclosure.

The one or more remote users determined according to the process are then selected as the remote outcome users from the group of users (Step 470) and a result of the solicitation event may be associated with the user data for each remote outcome user and stored in the server system 160 and/or database system 150 for each remote outcome user (Step 475). For example, the event remote outcome user may be a winning event participant who is determined on a basis of a pre-determined process, such as, for example, but not limited to, correctly selecting a winning participant of the in-store event, correctly answering a predetermined number of questions, performing one or more assigned tasks, or the like. In this regard, the result of the solicitation event (e.g. the remote outcome user has correctly selected the winning in-store event user) may be associated with the particular remote outcome user by, for example, creating one or more new entries in a record associated with the remote outcome user. The new entries may include data such as, but not limited to, for example, the name of the solicitation event, the date and time the event was executed, the name of the provider location at which the event was executed, the address of the provider location, the specific terms and/or conditions for the event, and the like.

After the result of the solicitation event have been associated and stored for the particular remote outcome users (Step 475) a message may be provided to each of the remote outcome users informing the users of the particular details of the result of the solicitation event, including, but not limited to, for example, a chit (e.g., a particular product and/or service the users may have won, a coupon for a particular product and/or service, a discount for a particular product and/or service) and a particular way in which the remote outcome users may obtain the chit (Step 480). The message may be provided to the outcome user as, for example, a spoken, a Braille or a displayed message at the provider location (e.g., the site of the event), via for example a short message service (SMS) message, an email message, a broadcast message, a television signal message, a radio message, a satellite radio message, a provider location-based message, or the like, or any combination thereof.

According to a further aspect of the disclosure, a computer program may be provided on a computer readable medium that, when executed, may cause a computer to carryout, for example, the exemplary incentive promoting process described above and shown in FIG. 4. The computer readable medium may include a plurality of code sections, including a code section corresponding to each of the Steps 410 through 480 shown in FIG. 4.

An exemplary application, but in no way limiting, of the process of FIG. 4 may include, for example, an owner of a newly opened retail store motivated to provide incentives to potential customers to visit and become familiar with the new store. The owner may provide discounts, store credits or other incentives to motivate a potential customer to visit the store. For example, the owner may provide incentive solicitations to on-site, in-store customers such as, but not limited to, for example, a reduced product cost or service cost, an in-store credit, or the like.

Additionally, the owner may provide incentive solicitations to remote, off-site customers, including, but not limited to, for example: an opportunity for the customer to inspect the product before it is picked up; an opportunity for the customer to delay payment until actually receiving the product; an opportunity for the customer to withhold payment if the product is not acceptable; an option for the customer to select a retail location at which to pick up the product or receive the service; an opportunity for the customer to select the most convenient remote location at which to pick up a product from among a plurality of retail locations; an opportunity for the customer to use a remote location for package pick up; an opportunity for the customer to receive a product at a reduced cost in exchange for a guaranteed purchase at the retail location; and an immediate incentive award to be redeemed at a desired retail location.

According to the exemplary, non-limiting application, the owner of the retail store may purchase equipment and/or subscribe to a service according to an aspect of the disclosure. Further, a host (e.g., store representative) located at the store location, or a system administrator located at the E-Aggregator system 100b, may create a new subscription account for the retail location, for example, at the computer 120 in the provider 100a or the server system 160 via the interface system 165 (shown in FIG. 1). The new subscription account may be created at the computer 120 via the handheld computer device 125, one of the transducer devices 110, 112, 114, the interface device 118 or the MTS 200 (shown in FIG. 2), which may be delivered to the retail location where the retail location does not have the necessary hardware and/or software to carry out an aspect of the disclosure. Alternatively, the new subscription account may also be created at the server system 160 via the interface system 165 using a peripheral input device such as, for example, a laptop computer, a workstation, a desktop computer, a palmtop computer, a notebook computer, or the like.

Still referring to the above exemplary application, one or more terminal systems (such as, e.g., the MTS 200 shown in FIG. 2) may be strategically placed within desired retail location(s). Image pickup and sound pickup devices may be strategically installed at shelves in the retail store. The new subscription account may identify the incentive solicitations considered to be important to particular users or groups of users and which may be offered to remote users. The new subscription account holder/retail location may submit solicitation event schedules for upcoming in-store incentive solicitation events to the E-Aggregator system, so that a retail location's subscription account may be updated and the updated schedule made available to the potential customers.

After the subscription account and the terminal system (e.g., MTS 200 shown in FIG. 2) have been setup, the incentive solicitation event schedules posted remotely and on-site at the retail location, and the incentive solicitation event benefit notification(s) in place, the retail location may solicit potential customers in the store to become part of the potential participant pool (e.g., a group of potential customers interested in participating in a particular solicitation event). The schedules may include, for example, the date and time of a “live” event solicitation. Potential participants may be assigned unique identifiers which may be entered into, e.g., the provider system 100a (shown in FIG. 1) through a pre-defined submission process. At the beginning of the actual solicitation event, or at some designated time before the actual solicitation event takes place, actual event participants may be selected from the potential participant pool by a predefined selection process.

The designated event participants having been chosen and present for the scheduled in-store event, the event may proceed as pre-determined, resolving the event participants down to a winning participant. The retail location may then connect to the E-Aggregator system 100b via the communications system 140 to broadcast an event “live” to remote users at user systems 100c. It should be noted that the event does not have to take place near the terminal system or on camera. The winning participant may receive a proposed incentive(s) for winning activities performed during the event.

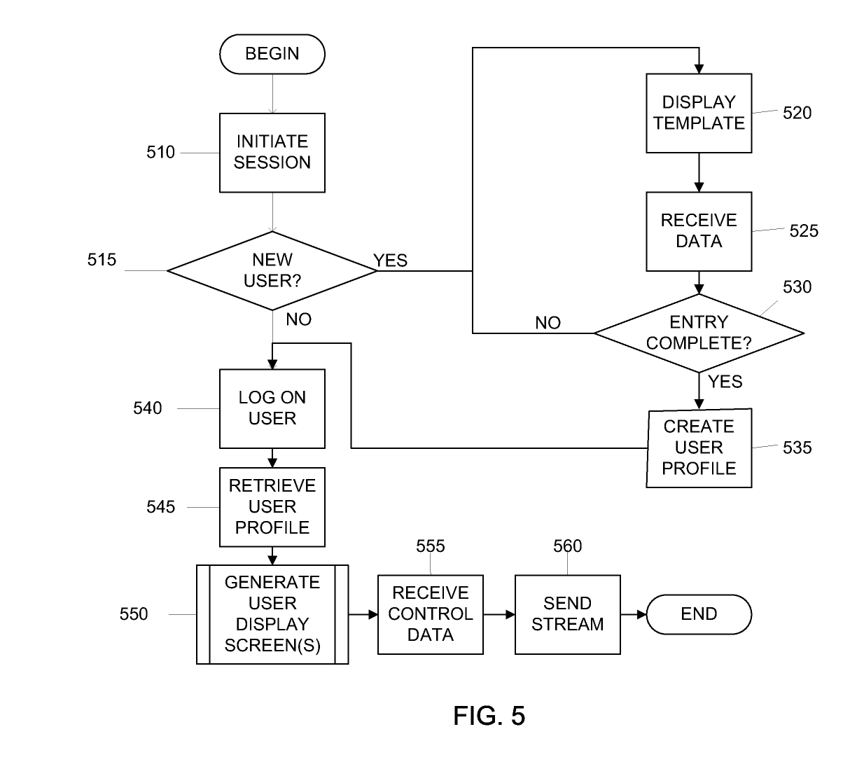

FIG. 5 illustrates an exemplary embodiment of a remote user E-system accessing process according to an aspect of the disclosure. According to an aspect of the disclosure, a remote, off-site user 100c may connect and log into the E-Aggregator system 100b (see FIG. 1). The remote user 100c may connect and log into the E-Aggregator system 100b as, for example, a provider-member, a service provider system member, an E-Aggregator system, a guest member, or a new member, where the guest member or new member may be any one of a provider, a service provider system, or a user that does not have an existing profile stored in the E-Aggregator system 100b.

Referring to FIG. 5, a user session is initially created between the user system 100c and the E-Aggregator system 100b (Step 510). The session may be created in response to a user request sent from the user system 100c to the E-Aggregator system 100b via the communicator device 170. The session request may be sent from the user system 100c to the E-Aggregator system 100b directly through the communications system 140 or via the communications system 140, the service provider system 100d and the communications system 140. In this regard, depending on a particular application of the disclosure, user requests may be relayed to the E-Aggregator system 100b through the service provider system 100d.

After establishing a connection with the user, a determination may be made whether a profile exists for the connected user in the E-Aggregator system (Step 515). If it is determined that a profile does not exist for the connected user (“NO” at Step 515), then a template may be sent to the connected user and displayed on, for example, a display of the user computer device 195 (Step 520). However, if it is determined that a profile exists for the connected user (“YES” at Step 515), then the user is logged into the E-Aggregate system 100b (Step 540) and the user's profile is retrieved and loaded into the server system 160 (Step 545).

The template that is sent to the connected user may include, but is not limited to, for example, at least one template screen having one or more fields for entry of data such as, for example, a country, a state, a county, a city, a province, a zip code, a desired distance radius, a market preference, a provider preference, a brand selection, a location selection and the like.

After the user has entered data into the various fields of the template screen, the data may be sent from the user computer device 195 and received by the E-Aggregator system 100b (Step 525). As noted earlier, the entered data may be sent directly to the E-Aggregator system 100b via the communications system 140, or the data may be sent to the service provider system 100d which then forwards the data to the E-Aggregator system 100b.

A determination may be made whether the received data is sufficient to create a profile for the user according to predetermined criteria (Step 530). The criteria may include, but is not limited to any one or more of the following, for example, a user name, a telephone number, a street address, a building address, a website address, an email address, a social security number, a credit card number, a bank account number, or any other information that may identify a particular person, as the skilled artisan will appreciate without departing from the scope and/or spirit of the disclosure.

If a determination is made that the received data is sufficient to create a profile for the user (“YES” at Step 530), then a profile is created for the user (Step 535) and the user is logged into the E-Aggregate system 100b (Step 540). After the user is logged into the E-Aggregate system 100b, the user's newly created profile is retrieved and loaded into the server system 160 and/or database system 150 (Step 545).

However, if a determination is made that the received data is not sufficient to create a profile for the user (“NO” at Step 530), then the template may again be sent to the user together with a message instructing the user to enter necessary data (Step 520).

As will be readily apparent to the skilled artisan, a similar process as that described above for collecting data from a user to create a user profile may also be performed to create a profile for a new provider system 100a or a new service provider system 100d.

Once the user has logged into the E-Aggregator system 100b and the user profile is retrieved and loaded, a user display screen(s) may be generated by the E-Aggregator system 100b for the particular user associated with the user profile (Step 550). Of course, it is not necessary that the user be logged into the E-Aggregator system 100b for the user display screen(s) to be generated. Instead, the user display screen(s) may be generated at any time based on the user profile and stored in the server system 160 and/or database system 150 for later retrieval and use.

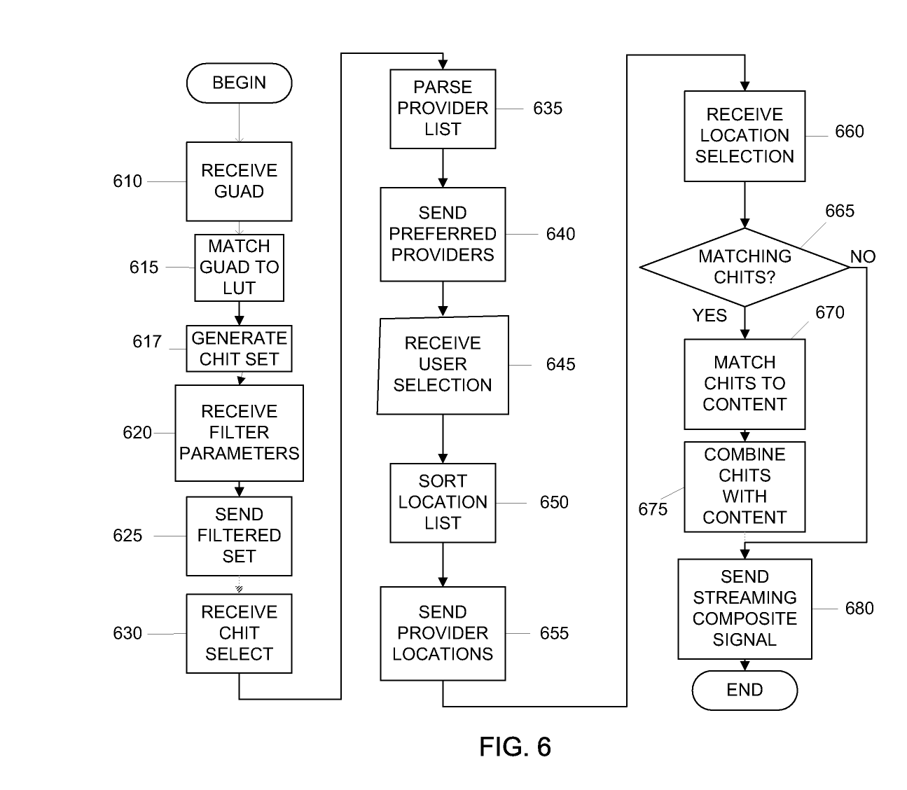

The user display screen(s) may be generated on a basis of the particular information contained in the user profile, including information such as, but not limited to, for example, the country, the state, the county, the city, the province, the zip code, the telephone number, the street address, the building address, the website address, the email address, a history of the user's purchasing behavior, a household income, etc. Additionally, the user display screen(s) may be generated on a basis of an interactive process with the user as illustrated in the exemplary non-limiting flow diagram shown in FIG. 6.

After the user display screen(s) is generated and sent to the user computer device 195, data and data selections entered by the user are received from the user computer device 195 and stored in the server system 160 (Step 555). On a basis of the received data and data selections, the server system 160 causes a customized streaming composite signal to be sent to the user computer device 195 (Step 560).

Although the above disclosure of FIG. 5 was provided from the perspective of the user accessing the E-System 100 via the user system 100c, the skilled artisan will recognize that substantially the same process may be carried out in the computer 120 at a provider location 100a (shown in FIG. 1).

According to a further aspect of the disclosure, a computer program may be provided on a computer readable medium that, when executed, may cause a computer to carryout, for example, the exemplary E-system accessing process described above and shown in FIG. 5. The computer readable medium may include a plurality of code sections, including a code section corresponding to each of the Steps 510 through 560 shown in FIG. 5.

FIG. 6 illustrates an exemplary process for generating a user display screen(s) that may be used in, for example, Step 550 in FIG. 5. According to an aspect of the disclosure, the exemplary user display screen generating process may be carried out in the server system 160 of the E-Aggregator system 100b (see FIG. 1).

Referring to FIG. 6, geographic user area data may be received from a user (Step 610). The geographic user area data (GUAD) may include data such as, but not limited to, for example, a country code, a state code, a county code, a city code, a province code, a telephone area code, a zip code, or the like, or a portion thereof enabling determination of a geographic area of interest (GAOI). The geographic user area data may be used to identify, for example, one or more provider locations within a desired radius of the geographic area of interest. The GUAD may be entered by the user into a field of a record or the GUAD may be selected via, for example, a drop-down menu.

The received GUAD may be compared to entries stored in, for example, a look up table (LUT) having a plurality of GUAD entries associated with a plurality of providers (Step 615). The LUT may be stored in the database system 150 for long-term storage. A set of a plurality of providers may then be generated on the basis of the comparison with the LUT (Step 617).

One or more filter parameters may be received and used to filter the generated set of providers on the basis of the received filter parameters (Step 620). The set of providers may be compiled on the basis of a provider category to generate a provider category listing. The provider category may include, but is not limited to, for example, a market segment, an industry sector, an organization type, a business type, a service type, a product type, or the like. The filter parameters may include such parameters as, but not limited to, for example, a distance radius around a particular zip code, a distance radius around a particular building address, and the like. The compiled provider category listing may then be sent to the user as a filtered set of providers (Step 625). The compiled provider category listing may be configured to include one or more lists such as, for example, retail brands contained within a desired radius of a selected zip code, or the like.

Additionally, the one or more received filter parameters may be used to filter one or more chits associated with the generated set of providers (Step 620). The filtered chits may be combined into a selectable chit set that may be presented to the user (a partaker user) who may wish to partake in a particular one or more chits in the selectable chit set.

After sending the compiled provider category listing to the user, provider category selection data may be received from the user (Step 630). The provider category selection data may, for example, identify a particular market preference of the user. The set of the plurality of providers may be parsed and stored on the basis of the received provider category selection data (Step 635) and a listing of preferred providers may be sent to the user (Step 640).

A preferred provider selection may be received from the user, identifying one or more desired providers (Step 645). The one or more desired providers may then be sorted on the basis of the stored filter parameters previously provided by the user (Step 650). The sorted preferred providers, including preferred provider locations, may then be sent to the user (Step 655).

At least one selection of a preferred provider and a corresponding preferred provider location may be received from the user (Step 660). The received preferred provider and the corresponding preferred provider location may be used to query, for example, the database system 150 for matching records containing chit information (Step 665). If a record containing chit information is found matching the query (“YES” at Step 665), then the chit information is matched to the query and retrieved (Step 670). The retrieved chit information may then be combined with a provider composite signal for the preferred provider and the preferred provider location (Step 675) and sent to the user as a streaming composite signal (Step 680).

However, if no records containing chit information are found in response to the query (“NO” at Step 665), then the provider composite signal is sent to the user (Step 680) without chit information.

According to a further aspect of the disclosure, a computer program may be provided on a computer readable medium that, when executed, may cause a computer to carryout, for example, the exemplary process for generating a user display screen described above and shown in FIG. 6. The computer readable medium may include a plurality of code sections, including a code section corresponding to each of the Steps 610 through 680 shown in FIG. 6.

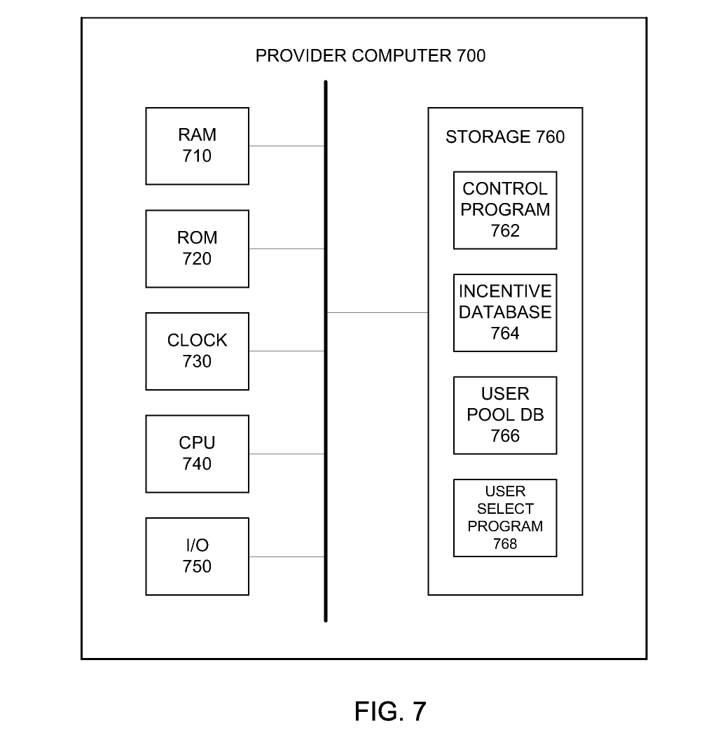

FIG. 7 illustrates an exemplary non-limiting embodiment of a computer that may be provided at a provider location according to an aspect of the disclosure.

Referring to FIG. 7, the provider computer 700 may be configured to include, for example, a random access memory (RAM) 710, a read only memory (ROM) 720, a clocking system (clock) 730, a central processing unit (CPU) 740, an input-output interface (I/O) 750 and a storage 760. The storage 760 may include at least four separate memory sections, including, for example, a control program section 762, an incentive database section 764, a user group (or pool) database section 766 and a user selection program section 768.

According to a preferred embodiment, the RAM 710 may be configured to provide working data storage for the CPU 740. The ROM 720 may be configured to provide fixed and persistent storage of data and program code used by the CPU 740. The clock 730 may be configured as, for example, an internal clock that controls the timing of operations performed by the CPU 740, as well as other components of the provider computer 700. The CPU 740 may be a general purpose processor configured to accept data, perform prescribed mathematical and logical operations at high speed, and output the results of these operations. The I/O 750 may be configured to enable the provider computer 700 to engage in data communication with the transducer devices 110, 112, 114, the interface device 118, the access point 130 and the handheld computer device 125 shown in FIG. 1. The storage 760 may be configured as a mass storage device that stores information, software, computer programs, databases, etc. The storage device 760 may preferably comprise an appropriate combination of magnetic, optical and/or semi-conductor memory, and may be constituted by one or more hard disks. The CPU 740 and the storage device 760 may each be, for example: (i) located entirely within a single computer or other computing device; or (ii) connected to each other by a remote communication medium, such as a serial port cable, telephone line or radio frequency transceiver.

The software and other information stored in the storage 760 may preferably include any one or more of the following: a control program, an incentive database, a user group (pool) database, or a user selecting program. The control program may be provided in a control program section 762 and configured for operating the provider system 100a (shown in FIG. 1). The incentive database may be provided in an incentive database section 764 and configured to store chits such as, but not limited to, for example, coupons or incentives prior to printing and awarding to a winning event participant. The user group (pool) database may be provided in a user pool database section 766 and configured to store potential participant unique identifiers. The user select program may be provided in a user select program section 768 and configured to cause the provider computer 700 to select actual event participants.

The control program residing in the control program section 762 may be configured to control the CPU 740. In this regard, the CPU 740 preferably performs instructions of the control program and thereby operates in accordance with the present disclosure, and particularly in accordance with the methods described in detail herein. The control program may be stored in a compressed, uncompiled and/or encrypted format. The control program may include program elements that may be necessary for proper operation of the provider computer 700, including, for example, but not limited to, an operating system, a database management system and device drivers for allowing the CPU 740 to interface with peripheral devices, databases, etc. Appropriate program elements are known to those skilled in the art, and need not be described in detail herein.

According to an embodiment of the present disclosure, the instructions of the control program residing in the control program section 762 may be read into a main memory from another computer-readable medium, such as the storage device 760. An execution of sequences of the instructions in the control program may cause the CPU 740 to perform the process steps described herein. In alternative embodiments, hard wired circuitry may be used in place of, or in combination with, software instructions for implementation of some or all of the methods (processes) of the present disclosure. Thus, embodiments of the present disclosure are not limited to any specific combination of hardware and software.

The provider computer 700 may generally be constituted by conventional hardware arrangements for such devices, except that, for certain embodiments of the disclosure, it is desirable that the provider computer 700 include a suitable display, such as a liquid crystal display (LCD), a cathode ray tube (CRT) display or other display device capable of displaying computer generated images, graphics, photographic images or the like. Each provider computer 700 may include two or more displays, including one facing an Event Solicitation Host (ESH) and another facing the on-site users. It is preferred that the display facing the on-site users be capable of displaying images. In other respects the I/O 750 may be configured for attachment to conventional peripheral devices such as, but not limited to, for example, a bar code scanner, an operator keypad, a magnetic stripe card reader such as a card authorization terminal, a receipt printer and the like.

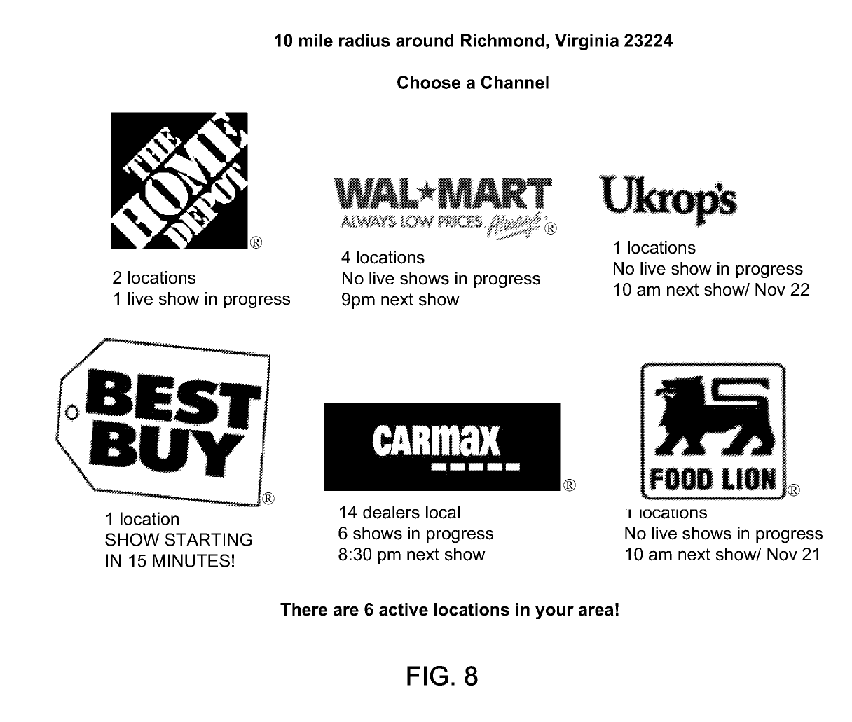

FIG. 8 Illustrates an exemplary options display which a user may view, according to an aspect of the disclosure. The illustration also includes an example of an advertisement that a user may receive during the selection of a provider location for a product pick up. The user may be able to experiment with the selection of different providers to see the chits offered by each. Some advertisements may be dependent upon the user's provider location selection. Some advertisements may be general advertisements which may not necessarily be related to any participating provider location. Referring to FIG. 8, the exemplary options display may include, for example, at least seven separate informational items, including a proximity information display section 810, a channel selection information display section 820, a provider identification information display section 830, a number of locations within the selected proximity information display section 840, a live even status information display section 850, an event schedule information display section 860 and a number of active providers within the selected proximity information display section 870.

As shown in the non-limiting example of FIG. 8, a possible result of the exemplary options display for a ten mile radius around a zip code 23224 may provide the results shown. According to a preferred embodiment of the disclosure, the options display may include a provider location address, a provider location name, an image, a current programming title, a countdown timer for a next “live” on-site solicitation. The options display may display fields to enable a user to, for example, select and update desired provider location options, to display a current media from a selected desired provider location, to obtain directions to the provider location via a map or “turn-by-turn”, to synchronize on-site content feeds, to manage and store content media, to generate and/or print chits at the user location and/or the provider location, to view or obtain a chit solicitation schedule, and the like. Of course, the example depicted in FIG. 8 is provided to facilitate a better understanding of the disclosure and is not meant to be limiting in any way.

Further, after a user confirms a provider selection and selects a provider location for viewing and/or listening, the options display may display web pages including both general advertisements and/or provider advertisements for a selected provider location where, for example, a chit may be redeemed. The displayed web pages may further include a “click here for special values” link, a pop-up advertisement, or other link that, when selected, links the user to a location of the advertisements for the provider location holding the event. Upon selecting the link, the user may be, for example, directed to a separate web page for that participating provider that is available at the web site of the E-Aggregator system, a separate web page for that particular provider that is available on the participating provider's web site, or another location on that particular web page.

Alternatively, after the user confirms the provider selection and selects the provider location for viewing and/or listening, the options display may display one or more television channels and/or reproduce one or more radio channel signals including both the general advertisements and/or the provider advertisements for the selected provider location where, for example, the chit may be redeemed. The displayed television channels and/or reproduced radio channel signals may further include, for example the “click here for special values” link or some other link that, when selected, links the user to the location of the advertisements for the provider location holding the event. In the case of the radio channel signals, the user may need to call a particular telephone number, or send a message identifying the user's selection using an SMS message, an email message, a broadcast message or the like. Upon selecting the link, the user may be, for example, directed to a separate television or radio channel for that participating provider that is available through the E-Aggregator system 100b and/or service provider 100d (shown in FIG. 1).

After selecting the “click here for special values” link, the user may be provided with a general or a specific advertisement or promotion from the provider. Additionally, the user may be provided with a general or a specific advertisement or promotion from a third party such as, for example, a manufacturer of a product or a supplier of a service.

In a preferred embodiment, information concerning the user and an associated chit may be matched with data for a provider or a third party regarding a likelihood of cross-selling opportunities for products and/or services carried by the provider location plus any general or specifically created promotions available from the provider or different third parties to provide a specific set of advertisements and promotions for a particular transaction. In such a preferred embodiment, the specific set of advertisements and promotions for this transaction may be located on an individual web page created just for that transaction. This type of advertising may encourage the user to view that individual web page.

According to an aspect of the disclosure, an e-mail message may be directed to a user at the time a solicitation is completed and a chit awarded. The content of the e-mail message may include the same advertisements and promotions as described above, or a different set of advertisements and promotions, or directions to a specifically created web page for a particular transaction which would display those advertisements and promotions.

Although the E-Aggregator system may release a physical address or an e-mail address for a particular user to a provider, in the preferred embodiment, the physical address and the e-mail address should not be released. In so limiting dissemination of user information to providers, users may be less likely to receive a continuing and uncontrolled volume of direct mail or direct e-mail and thus more likely to use the system in accordance with the disclosure. All messages from a provider associated with a product or service may be sent to the E-Aggregator system for delivery to a particular user. The E-Aggregator system may selectively send some or all of the messages to the particular user where identification information is received for a particular transaction or class of transactions. Such messages may be sent individually or the messages may be combined with other E-Aggregator messages to be sent to the user.

It should be noted that many other channels of communication with the user, besides e-mailing, are available and may be used. After solicitation redemption, the provider's advertisements and promotions may be included in a combined E-Aggregator system and provider message thanking the user for using the system.

Advertising and e-mail messages may also be directed to the user during the user's Internet-access sessions, or other interactive connections which may be unrelated to the chit transaction. For example, a possible approach may be to use identifiers such as, for example, “cookie” technology, which may be located in the user's computer, interactive television device, wireless device, or other interactive device which identifies the user.

In such instances, the E-Aggregator system may direct advertising from the retail location associated with the chit redemption, and from other advertisers to the user during the user's other usages of the Internet connection. For example, an audio advertisement may be sent to the user when the user is using an Internet connection for radio reception or downloading music. Further, a video advertisement may be sent as a part of movie being received by the user over the Internet. Further, a video advertisement may be sent to a user as part of a commercial television signal over the Internet or by means of a cable television system where reception may be individualized to the user. Further, a text, an audio or a video advertisement may be sent to a user when the user accesses the Internet by means of a hand-held Internet telephone device or other device. Further, text, audio or video marketing may be provided to a user through an “always on” Internet connection such as, but not limited to, for example, a cable connection, a modem connection, a dedicated line connection, a service connection, or the like. Further, an advertisement may be provided a user through any interactive television or communications medium where the user's identity is known.

Furthermore, the advertisement may be provided to one or more users whose identities are not known. For example, an advertisement may be provided to all users viewing or listening to a particular program event and a chit may be awarded to some (or all) of the user via an interactive communication medium when a predetermined event takes place. In this regard, a particular advertisement may be provided to, for example, one-hundred-thousand users watching a NASCAR™ event where the users are interactively offered a chit when a HOME DEPOT™ car goes by. Should a user select the chit, a message may be displayed on the user's display such as, for example, a confirmation code that may be validated at a local HOME DEPOT™ store to redeem the chit.

In an alternative embodiment, the E-Aggregator system may preserve the anonymity of a user. The E-Aggregator system may elect not to release information identifying the user to the provider, including the name or any other data about the user. Alternatively, the E-Aggregator system may elect to release general information such as, for example, a zip code location, an area code, a type of product to be delivered and the like. The E-Aggregator system will then match the identity of the user to predefined advertising and promotions from the provider and create and send individualized advertisements and e-mail messages.

According to an aspect of the disclosure, a unique relationship may be created between the user and a provider where the provider knows that the user will be coming to a specific provider location within a defined time frame. The E-Aggregator system knows the identity and e-mail and/or Internet connection address of the user and is able to create an individualized direct marketing relationship based upon this knowledge. Such a marketing effort may be for the chit solicitation of the provider, as the skilled artisan will appreciate. Additionally, as a result of information available from the chit redemption experience, an integrated marketing effort may be compiled for a user who is known to be coming into a specific provider location.

The E-Aggregator system may have significant information about a particular user, including historical shopping behavior, which may be used for effective advertising and marketing. In particular, the E-Aggregator system may know where the user lives and approximately when the user will travel to pick up a product or a chit at a particular provider location. This information may be of interest to another provider located along or near the route the user may travel to the particular provider location to pick up the product or chit. Therefore, the other provider may have an interest in direct-marketing to this user. This may be of value to both the E-Aggregator system and any of a number of providers. Such direct marketing may include an e-mail message, an instant message, an SMS message, an electronic billboard sign, or the like, to the user before, during, or after traveling to the particular provider location to pick up the product or chit.

Additionally, the E-Aggregator system has the identity of the user and at least the location of the particular provider location along with the approximate time the user will travel to the provider location to pick up the product or chit. Information about the identity of a user when such a user plans to visit a provider location, as well as information regarding what that user intends to pick up, along with other information, provides to the E-Aggregator system and the provider a very powerful tool for customized advertising for a known user with a known product interest. As a result, the system disclosed herein provides a unique marketing tool to the provider to present focused advertising to the user before, during and after visiting a provider location to pick up a product or chit. The E-Aggregator system may also generate chit solicitation from such information by directing advertisements to the user from other providers that may be interested in attracting a particular user to their locations.

Hence, a method and system are provided for directing marketing messages to particular users prior to, at the time of, or after product or chit pick up. The marketing messages may be sent to a user using any number of methods including, but not limited to, for example, an e-mail message, a telephone message, an instant message, an Internet connection, or an individual cable television address. Such marketing messages may be sent from a provider directly to a user, or through the E-Aggregator system. Such advertising is a unique form of direct marketing as it combines the user profile described above with the solicited chits. Further, according to an aspect of the disclosure, customized marketing may be directed to a user who is known to be coming into a particular provider location; the user has chosen the remote location chit redemption; the time frame within which the user will come into the particular provider location is known; the advertising and direct e-mail messages can be timed to arrive just before the user comes into the particular provider location; the chit redemption experience creates a relationship between the user and the particular provider location; the E-Aggregator system knows who the user is; and the E-Aggregator system knows the location of the user.

The E-Aggregator system may direct messages to a user from sources unrelated to the particular provider location based upon a profile associated with the user. As described above, the profile may include, but is not limited to, for example, a type of chit received, a type of provider location from which the chit must be redeemed, the location of particular provider from which the chit will be redeemed, and the name and location of the user.

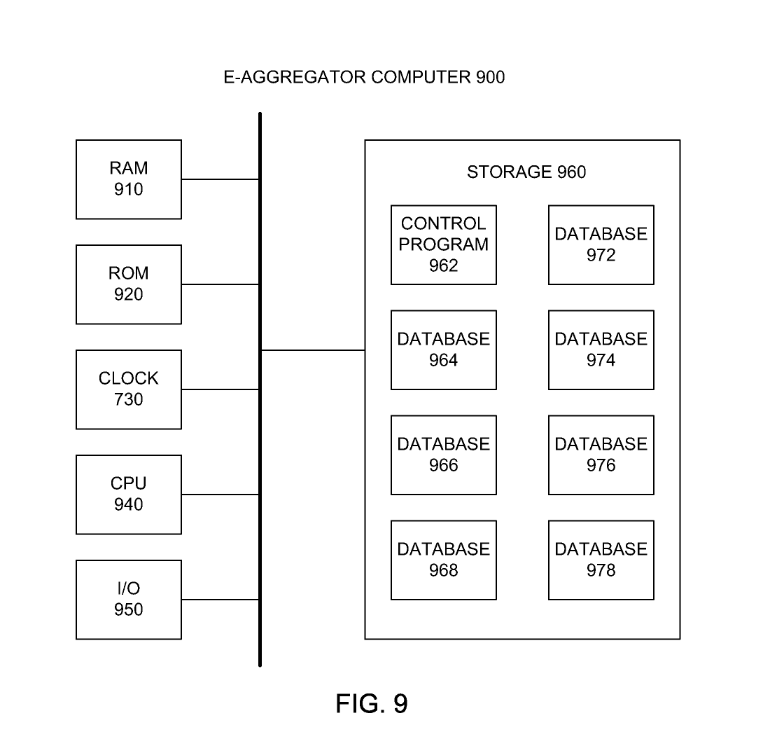

FIG. 9 illustrates an exemplary non-limiting embodiment of a computer that may be provided in the E-Aggregator system according to an aspect of the disclosure.

Referring to FIG. 9, the E-Aggregator computer 900 may be configured to include, for example, a RAM 910, a ROM 920, a clock 930, a CPU 940, an I/O 950 and a storage 960. The storage 960 may include at least eight separate database sections 962, 964, 966, 968, 972, 974, 976 and 978. The clock 930 controls the timing of operations performed by the CPU 940. The ROM 920 and RAM 910 respectively provide fixed and working data storages for the CPUT 940. The I/O 950, which may include one or more input/output devices, facilitates communication between the various components internal to the E-Aggregator computer 900 with components external to the E-Aggregator computer 900. Such external components may include, for example, systems 100a, 100c, 100d and 140 (shown in F16.1), as well as devices such as a printer and an operator terminal with a display, a keyboard and a mouse.

The hardware components of the E-Aggregator computer 900 may be constituted by conventional computer hardware, such as, for example, a mini computer, a mainframe computer, a server computer of the type employed to manage a system of POS terminals, or the like. The E-Aggregator computer 900 includes a CPU 940 that is in communication with or otherwise uses or includes one or more communication ports (not shown) to enable data communication between the E-Aggregator computer 900 and each of the provider system 100a, the user system 100c, the service provider system 100d and the communications system 140 (shown in FIG. 1). The data communication between the E-Aggregator computer 900 and the systems 100a, 100c and 100d may be carried out via the communications system 140, or any other conventional data communications medium as will be understood by the skilled artisan depending on a particular application of the disclosure.

Also included in the E-Aggregator computer 900 is a mass storage 960 which stores information, software, programs, databases, etc. The storage 960 preferably comprises an appropriate combination of magnetic, optical and/or semi-conductor memory, and may be constituted by one or more hard disks. The CPU 940 and the storage 960 may each be, for example: (i) located entirely within a single computer or other computing device; or (ii) connected to each other by a remote communication medium, such as a serial port cable, a telephone line, a radio frequency transceiver, or the like.

The software and other information stored in the storage 960 preferably includes any one or more of the following: a control program 962 for operating the E-Aggregator computer 900; a provider location database 964 for storing information about provider locations subscribing to the E-Aggregate system 100b; a chit database 966 for storing information about chit offers that may be made through the system 100; a user profile database 968 for storing information about one or more users; an outcome database 972 for storing information to be used in determining outcomes in accordance with the disclosure; a presentation database 974 for storing information, graphics, etc. for interfaces that may be presented by the system in connection with the outcomes; a transaction database 976 for storing information related to transactions handled by the system 100; and an up sell database 978 for storing information concerning up sells that may be offered to users through the system 100.

Each of the databases 962, 964, 966, 968, 972, 974, 976 and 978, including a use and a potential data structure will be discussed in more detail below. As will be understood by those skilled in the art, the schematic illustrations and accompanying descriptions of the databases presented herein are exemplary arrangements for stored representations of information. A number of other arrangements may be employed besides those suggested by the illustrations shown. Similarly, the illustrated entries of the databases represent exemplary information only. Thus, those skilled in the art will understand that the number and content of the entries can be different from those illustrated herein. Not all of the databases 962, 964, 966, 968, 972, 974, 976 and 978 will be used or needed in every embodiment according to the disclosure.

The control program 962 controls the CPU 940. The CPU 940 preferably performs instructions of the control program 962 and thereby operates in accordance with the present disclosure, and particularly in accordance with the methods described in detail herein. The control program 962 may be stored in a compressed, uncompiled and/or encrypted format. The control program 962 may further include program elements that may be necessary for the E-Aggregate computer 900 to function, including such elements as, but not limited to, for example, an operating system, a database management system and one or more device drivers for allowing the CPU 940 to interface with peripheral devices, databases, etc. Appropriate program elements are known to those skilled in the art, and need not be described in detail herein. According to an embodiment of the present disclosure, the instructions of the control program 962 may be read into a main memory from another computer-readable medium, such as the storage 960. Execution of sequences of the instructions in the control program 962 may cause the CPU 940 to perform the process steps described herein. In alternative embodiments, hard wired circuitry may be used in place of, or in combination with, software instructions for implementation of some or all of the methods of the present disclosure. Thus, embodiments of the present disclosure are not limited to any specific combination of hardware and software.

FIG. 10 illustrates an another exemplary non-limiting embodiment of an E-system 1000 including an exemplary data center 1300 according to an aspect of the disclosure. The exemplary datacenter 1300 may be configured to include a plurality of central servers 1070, a plurality of network systems 1090, a plurality of routers 1100, which act as a link between the datacenter 1300 and the communications system 140 (see FIG. 1), a plurality of streaming servers 1110 that send and receive information from the different entities using the communications system 140 and a plurality of virtual private network (VPN) servers 1140 that communicate with a plurality of remote, off-site users 1050, a plurality of provider systems 1060, each of which may use encryption channel technology so that the information coming in and out of the datacenter 1300 is safe from being intercepted and understood by unauthorized users. Since the skilled artisan will appreciate that many of the various components of the datacenter 1300 are well-known in the related art, a detailed description of the components is omitted to simplify the disclosure provided herein.

The datacenter 1300 may be configured to include a plurality of web site structured query language (SQL) servers 1130, a plurality of distribution SQL servers 1140 that distribute and transfer data between the different entities and the datacenter 1300, a plurality of primary SQL servers 1150 and a catalog database 1160 containing a primary provider location data database 1170 and a primary user data database 1175 that stores user data. These databases may be directly connected to the primary SQL servers 1150, with a copy of the provider location data primary database 1170 attached to the web site SQL servers 1130 and a copy of the primary user data database 1175 attached to the distribution SQL servers 1140.

The primary provider location data database 1170 may also be attached to the distribution SQL servers 1140. The primary retail locations data database 1170 may includes individual provider locations data 1180, on-site event schedule data 1190, incentive data 1200 and remote solicitation parameter data 1210. The primary user data database 1175 may be coupled to a search data database 1230 and a chit history data database 1240. The skilled artisan will appreciate that the data from both the provider location data primary database 1170 and the primary user data database 1175 are an integral part of the system 1000.

For example, an exemplary process according to the disclosure may comprise the steps of searching for a desired location by a geographic area, a distance parameter and a provider category, and displaying one or more desired providers and provider locations found by conducting the search. Upon selection of a particular provider and a particular provider location, the user may receive a pre-recorded composite signal for the particular provider and provider location. Additionally, the user may receive a “live” streaming composite signal from the particular provider and provider location, which may be received directly from the provider location or the E-Aggregate system 100b (shown in FIG. 1). The “live” composite signal may include an event time and/or date, a provider's name, an image, a location quantity, a current content title, a direct marketing banner, a remote solicitation event identifier, people and/or product names, a listing of chit events to be provided by the provider location, and the like.

The prerecorded composite signal and/or the “live” streaming composite signal may be provided to the E-Aggregator system 100b by the particular provider (see FIG. 1). For example, the particular provider may enter data at the provider system 100a such as, for example, data about a product or service, an event, a chit, a promotion, and the like, and send the entered data together (or separately) with a composite signal including, for example, a streaming video signal. The composite signal may include moving images of different views of the provider's building, products, people, or the like. Further, the composite signal may include live images or prerecorded images of a solicitation event at a provider's location. The composite signal, together with the entered data, may then be forwarded from the provider system 100a to the E-Aggregator system 100b via the communications system 140 (see FIG. 1).

Where a provider has advance knowledge of an event to be conducted at a particular time and place, the provider may enter, for example, a title for the event, a place for the event, one or more chits associated with the event and a schedule time for the event as the entered data discussed above. The entered data may then be transferred to the E-Aggregator 100b and, in particular, the datacenter 1300.

The E-Aggregator system 100b receives the composite signal and entered data from the provider system 100a and parses the information contained in the received composite signal and data into parsed information. The parsed information is then sorted, processed and stored in, e.g., the data center 1300 (shown in FIG. 10). Further, as appropriate, the E-Aggregator system 100b may submit a request to, for example, a video production vendor together with the parsed information for customized editing of the live or prerecorded provider signals.

According to one aspect of the disclosure, a Microsoft Synchronization Manager may be implemented in the datacenter 1300 of FIG. 10 to connect the provider system 100a with the distribution servers 1140 and to download the parsed information discussed above into, e.g., the submission results data database 1180, the incentive tally data database 1190, the user data database 1280 and the chit data database 1240 (shown in FIG. 10).

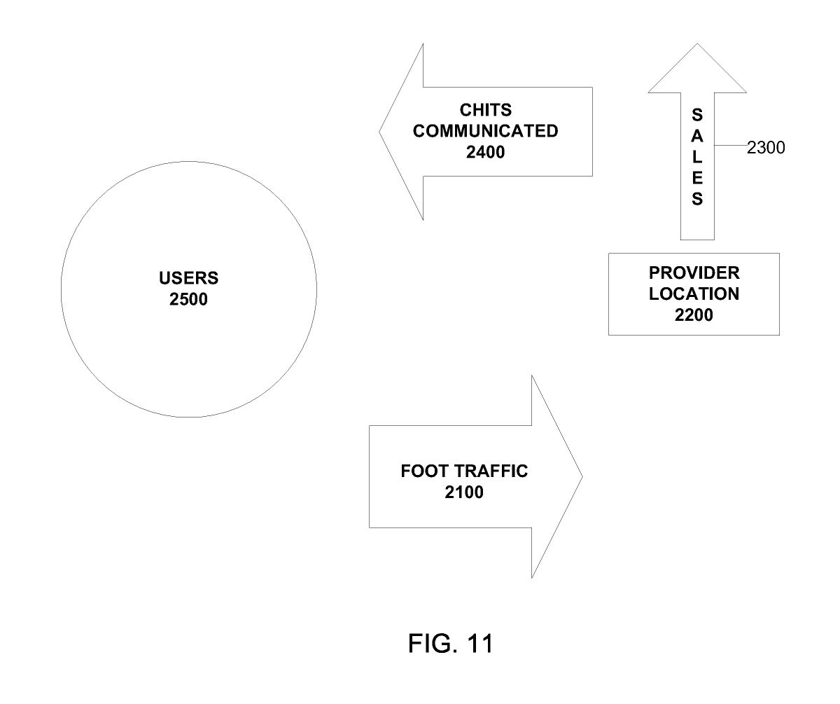

FIG. 11 illustrates an exemplary flow diagram showing different aspects of a direct marketing process according to an aspect of the disclosure.

Referring to FIG. 11, the exemplary, non-limiting direct marketing process includes a provider location 2300 that may participate in the process upon receiving data about an upcoming visit by a user 2500. In one non-limiting example, a web page advertisement may be forwarded to the user 2500 at the time user arranges for shipping of a particular product. Moreover, a chit may be communicated to the user 2500 together with the advertisement. Additionally, a promotion or chit 2400 may be included on a claim check the user 2500 receives and which may be required to pick up or drop off the product at the provider location 2200. Additionally, another web page advertisement may be generated when, and if, the user 2500 checks the status of the shipping of the product. The advertisement may be sent to the user 2500 in the form of, for example, an email message to the user along with a notice that the product has been shipped or is en route, or at the time the product is delivered to the provider location 2200. The advertisement may be sent to the user 2500 after the product is picked up or dropped off by the user.

As will be appreciated, the advertisement or chit may be sent to the user 2500 via a television signal, a radio signal, an email message, an SMS message, a broadcast message, a telephone message, and the like.

When the provider knows a user 2500 will be visiting the provider location 2200 within a given time frame to pick up an item, the provider has a valuable opportunity to very efficiently focus a marketing effort to the user 2500 known to be visiting the provider location 2200. This may result not only in additional products or services being purchased by the user during the visit for item pick up, but it may also result in additional subsequent user 2500 visits and purchases at the provider location 2200, thereby increasing foot traffic 2100 and sales 2300 to the provider location 2200. Over time, valuable user loyalty may be developed.

While the mere fact a user 2500 is known to be visiting a provider location 2200 is sufficient for some level of marketing, at least minimum information about the user is needed for more focused marketing efforts. As an example, the user name would, in most cases, provide to the provider location or the E-Aggregator system an opportunity to correlate profile information for more details about the user 2500 and, as a result, permit the provider location 2200 an opportunity for more pointed marketing directed at the user 2500.

Therefore, direct marketing may be tied into a known future event, such as a visit of a user to an exact provider location and the time frame within which such a visit will occur.

It should be appreciated that there is value in direct marketing to a user known to be en route to a provider location and that this value may be appreciated by an unrelated provider location the user may be near en route to while traveling to the provider location. Therefore, as a further aspect of the disclosure, a method of direct marketing discussed herein may also be made available to this unrelated provider location.

Table I below shows an exemplary representation of a plurality of records stored in the provider location database 964 (shown in FIG. 9) for the provider category “New Car Dealer” within a predetermined radius of the zip code 23234. Table I has, for example, five columns of entries, including a provider name column, a provider address column, an event time column, a playing status column and a provider log column. The example shown below includes three separate records for three separate providers found to be within a predetermined radius from the zip code 23234.

TABLE I
PROVIDER CATEGORY
New Car Dealer Zip Code 23234

| Name | Address | Event Time | Playing | Logo |
|---|---|---|---|---|
| Name 01 | Address 01 | 18:00 | Commercial | |
| Name 02 | Address 02 | 23:00 | Infomercial | |
| Name 03 | Address 03 | In Progress | Show in Progress | |

As shown above, the selected zip code (ZC) is shown as an entry in the table. The provider name column includes a plurality of fields for storing names of the respective provider locations (e.g., Name 01, Name 02 and Name 03). The provider address column includes a plurality of fields for storing provider location addresses (e.g., Address 01, Address 02, and Address 03). The event time column includes a plurality of fields for storing scheduled times for “live” events (e.g., 18:00, 23:00 and “In Progress”). The playing status column includes a plurality of fields for storing current content identifiers (e.g., Commercial, infomercial and Show in Progress). The provider log column includes a plurality of fields for storing data representative of images of the respective products. Instead of storing the image data itself in provider log column, the fields in the column may store pointers to locations in a separate image database, which is not shown.

Although not represented in Table I above, additional data fields may be supported by the provider location database, including, but not limited to, for example, data indicative of a product discount special, a quantity of inventory on hand, remote event solicitations, and the like.

Although only three records are shown in Table I, it is contemplated that in practical embodiments of the disclosure a large number of entries corresponding to all sale aspects of provider locations may be stored in the provider location database.

Table II below shows an exemplary representation of a plurality of records stored in the incentive database 966 (shown in FIG. 9) for a provider. “Brian Electronics.” The Table II has, for example, four columns of entries, including a chit identifier column, a display message column, an image column and a chit rules column. The example shown below includes three separate records for three separate chits.

TABLE II
CHIT CATEGORY
Brian Electronics

| Chit | Display Message | Image | Chit Rules |
|---|---|---|---|
| 1356DC | 10% Off 'Til 5PM today | ## | Use date . . . |
| 1360GC | $25 Gift Certificate | #$ | Use date . . . |
| 1364FP | Free Mystery Product | !@ | Use date . . . |

As shown above, the chit identifier column includes a plurality of fields for storing codes that identify particular chits; the display message column includes a plurality of fields for storing messages to be displayed at the provider system location 100a or to be displayed to remote users in regard to respective chits when the respective chits are to be awarded as a chit solicitation to the user 100c (see FIG. 1); the image column includes a plurality of fields for storing either a plurality of images for indicating respective chits or a plurality of pointers linking to a plurality of images provided on a separate image database in which the chit images may be stored. The chit rules column includes a plurality of fields for storing rules indicating the terms and conditions for providing a chit solicitation to the user. Such rules may include, for example, a rule requiring an award of a certain chit be awarded if a product corresponding to the chit was purchased in a previous transaction but not in the current transaction. Further, a rule may be provided requiring that a certain chit may be awarded if the user has viewed particular provider location content on at least three prior occasions.

Table II above shows entries for three separate chit records. However, the skilled artisan will readily appreciate that the disclosure is in no way limited to the number of columns, rows or records shown above. Rather, Table II may have any number of columns, rows or records, depending on the particular application of the disclosure without departing from the scope and/or spirit of the disclosure.

Table III below shows an exemplary representation of a plurality of records stored in the user profile database 968 (shown in FIG. 9) for a plurality of users. Table III has, for example, five columns of entries, including a column labeled “ID” for storing a plurality of user identifiers (e.g., 1001, 1111, 1112), a column labeled “Name” for storing a plurality of user names associated with each stored ID (e.g., Name 1, Name 2 and Name 3), a column labeled “PWord” for storing a plurality of passwords for each of the user names (e.g., *****), a column labeled “ZC” for storing a plurality of most recently searched zip codes for each user name (e.g., 23224, 23254 and 24453), a column labeled “Radius” for storing a plurality of most recently entered values for a radius search for each user name (e.g., 10, 50 and 70) and a column labeled “Mix” for storing a plurality of preferred market identifiers that identify markets engaged in by the respective users (e.g., CD, E, VG, HI, G). Although only three market identifiers are shown in the drawing, it is contemplated to store a considerably larger number of market preference identifiers for each user. The purpose of the user database may be to assemble comprehensive user purchasing histories.

TABLE III
USER DATABASE

| ID | Name | PWord | ZC | Radius | Mix |
|---|---|---|---|---|---|
| 1001 | Name1 | ***** | 23224 | 10 | CD, E, VG |
| 1111 | Name2 | ***** | 23254 | 50 | CD, E |
| 1112 | Name3 | ***** | 24453 | 30 | HI, G |

The exemplary Table III shown above includes three separate records for three separate user names (e.g., Name 1, Name 2, Name 3). However, the skilled artisan will readily appreciate that the disclosure is no way limited to the number of columns, rows or records shown above. Rather, Table III may have any number of columns, rows or records, depending on the particular application of the disclosure without departing from the scope and/or spirit of the disclosure.

Table IV below shows an exemplary representation of a plurality of records stored in the chit database that may be provided in the storage 960 (shown in FIG. 9) for a given user. Table IV has, for example, two columns of entries, including a column labeled “Chit” for storing a plurality of types of chits that may be offered to the given user and a column labeled “Probability” for storing the likelihood or probability of occurrence of each type of chit listed in the “Chit” column.

TABLE IV
CHIT DATABASE

| Chit | Probability |
|---|---|
| Upsell Offer | 5 |
| Free Product | 5 |
| Discount | 60 |
| Gift Card | 5 |
| No Prize | 20 |

As shown in Table IV above, exemplary types of chits that may be included as entries in the chit column include, but are not limited to, for example, an up sell offer, a coupon, a free product or service, a discount on a product or service selected by the user, no prize, a cash prize, a designation of all products or services selected for purchase to be free of charge, a product or service that the user has not selected for purchase, and the like. If a product or service that was not selected for purchase is to be awarded, the product or service to be awarded may be selected by taking into account the products or services selected for purchase by the user, the user's purchasing history, or a transaction total. A chit to be awarded to a user may include a discount on a product subscription. A product subscription may include an arrangement whereby the user receives a discount in exchange for agreeing in advance to purchase a quantity of a product to be delivered in installments over time. Furthermore, a product selected for purchase by the user may be awarded free of charge, or several products may be selected and a choice presented to the user to select one of the several products to be awarded to the user free of charge. Moreover, additional types of chits may be added to or deleted from the chit column as will be readily apparent without departing from the scope or spirit of the disclosure.

The probability column of Table IV is shown as including five entries associated with the five entries of the chit column, respectively. The values for each entry in the probability column are variable and may be changed depending on, for example, a likelihood of an occurrence of a given chit depending on certain circumstances. For example, when a chit such as an up sell or a coupon is to be awarded, the probability of awarding the chit may be increased, thereby increasing the likelihood that a particular chit will be selected. The probability of awarding the chit may depend on factors such as, for example, the relative amounts that a respective sponsor may be willing to pay to the provider.

Further, after a particular type of chit has been determined, a particular chit of that type may be selected. For example, when it is determined that the user is to be awarded a particular chit such as a product or service free of charge, the chit may be selected and awarded to the user when user elects to purchase the particular product or service, or one substantially similar.

It is contemplated that in determining the type of chit for a particular user and a particular transaction, the chit itself may be determined. For example, if a type of chit is determined to be a chit such as an up sell and there is only one up sell to be offered, then the chit is determined. That is, only one chit may be included in the set of chits to which the type of chit corresponds. Moreover, if a transaction consists of only one product to be selected for purchase by a user, then a determination to award that the type of chit will result in awarding the purchased product to the user free of charge.

Table IV above shows entries for five separate chit records for a given user. However, the skilled artisan will readily appreciate that the disclosure is no way limited to the number of columns, rows or records shown above. Rather, Table IV may have any number of columns, rows or records, depending on the particular application of the disclosure without departing from the scope and/or spirit of the disclosure.

According to an exemplary non-limiting embodiment of the disclosure, multimedia content signals may be provided from a provider location and forwarded to one or more user locations. The following description provides exemplary (but non-limiting) applications of various aspects of the disclosure.

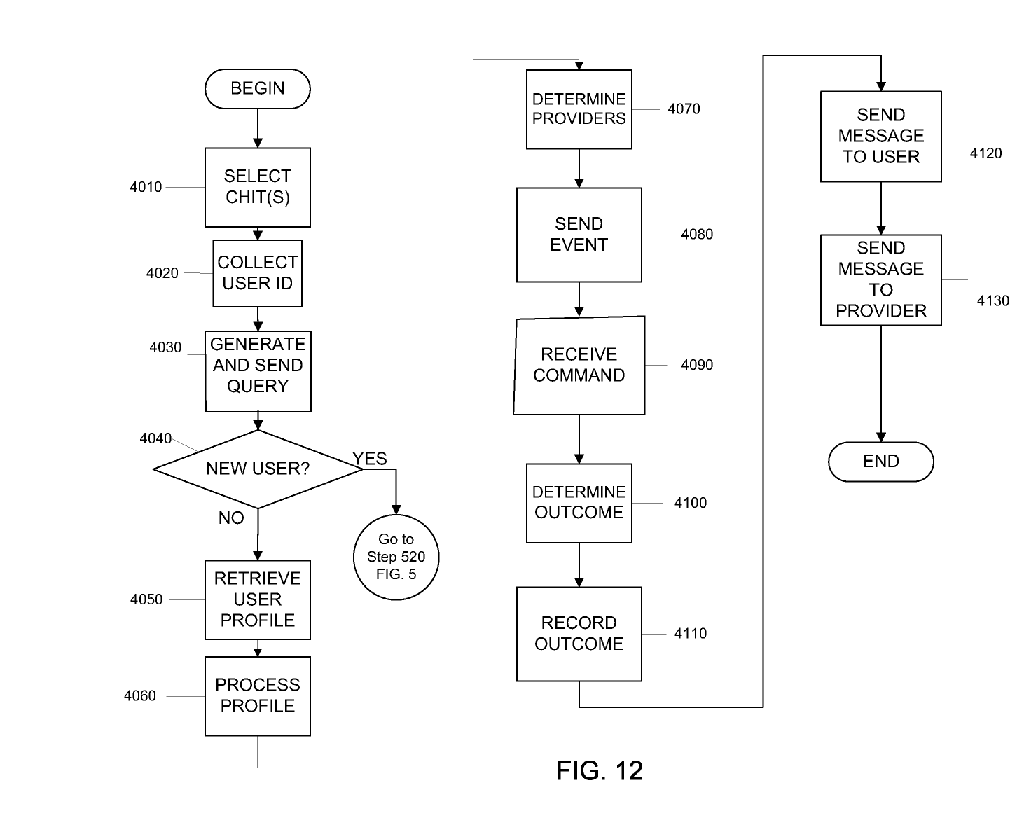

FIG. 12 illustrates a flow diagram of an exemplary non-limiting chit award process according to an aspect of the disclosure.

Initially, a user selects one or more chits of interest provided during a solicitation event (Step 4010). Depending on the particular media used by the user to access the solicitation event, the selection may be performed by, for example, the user selecting a link on a provider's content broadcast web page using an interface device (such as, e.g., a keyboard, a pointer, a mouse, a touch-screen display, etc.), selecting a displayed item on a displayed still or moving image (such as, e.g., a movie, an infomercial, a commercial, a video clip, a still image, or the like) using, e.g., a television receiver or settop box remote control, calling a particular telephone number and selecting an announced item using a keypad or interactive voice recognition (IVR) technology, and the like.

Further, the displayed still or moving images may include simultaneously displaying streaming composite signals from multiple providers using, for example, picture-in-picture technology, windows technology, special effects technology, or the like, as the skilled artisan will readily appreciate without departing from the scope and/or spirit of the disclosure.

A user identifying code is received for the particular user to identify the user (Step 4020). The user identifying code may be received by, for example, collecting data entered into a particular field of a template of the provider's web page displayed on the user's computer. For example, the user may enter a user name and a password into text fields on the web page. Alternatively, the user may be identified by identifying the machine the user is using to access the web page by, for example, detecting the MAC address of the computer, or the like. Additionally, the user identifying code may be provided prior to the step of receiving the user selection of one or more chits.

Alternatively, the user identifying code may be received by, for example, collecting the data entered into a particular field of a template displayed on a television display or selection of a particular image portion displayed on the television display. The template or image portion may be displayed integrally with the solicitation event, superimposed on the solicitation event, or as a separate display screen. The data may be received in the television receiver (not shown) or a settop box, which may be included in communicator 170 (shown in FIG. 1), from a remote control transmitter (not shown) or other interface device (not shown).

Furthermore, the user identifying code may be received by, for example, collecting the data entered into a mobile telephone-device (such as, e.g., 125 shown in FIG. 1) via an actual or virtual keypad, sound, or the like.

Having identified the particular user, a query may be generated and forwarded to, for example, the database system 150 (shown in FIG. 1) to find a profile record for the particular user (Step 4030). A determination may be made whether a profile record exists for the particular user (Step 4040). If it is determined that a profile record does not exist for the particular user (“NO” at Step 4040), then the user may be directed to a new user template (Step 520 in FIG. 5). However, if it is determined that a profile record does exist for the particular user (“YES” at Step 4040), then the profile record is retrieved and loaded into, for example, the server system 160 (Step 4050).

The profile record may contain information for the particular user such as, for example, a name, a street address, a building address, a website address, an e-mail address, a telephone number, a history of shopping behavior, a history of purchasing behavior, a history of chits previously awarded, a history of chits redeemed, a redemption reliability factor (e.g., indicative of a likelihood that the user will attempt to redeem a particular chit if awarded such a chit), and the like.

The received profile record may then be processed to determine weighting factors (Step 4060). For example, the profile record may be processed to determine whether to award the selected chits to the user, to offer additional chits to the user, which chits to make available as possible outcomes of a random selection process to be undertaken in connection with a solicitation event or some other outcome dependent on the profile record. Further, the random outcome produced by the random selection process may depend in part on any chits that may have been previously offered and/or awarded to the user.

Further, based on the selected chits and the retrieved profile record for the user, one or more providers (including respective provider locations) may be determined (Step 4070). For example, the one or more providers may be selected based on the particular chits selected, a distance radius the user is willing to travel to pick up a particular product or service, a history of past visits by the user to certain of the providers, and the like.

After the one or more providers have been selected, an event signal is sent to the user (Step 4080). In this regard, the event signal may be sent to, for example, the user's computer device 195 (shown in FIG. 1), the user's television receiver (not shown), the user's television settop box, the user's mobile telephone receiver (not shown) and the like. The event signal may include, for example, a live game show being conducted at a location of at least one of the selected providers, in which the user may participate remotely, or a game display showing a virtual slot machine with spinning “reels” of game indicia, in which the user may trigger the “reels” to spin by inputting a command signal at the user's computer. In either case, a command signal is received from the user (Step 4090).

In the latter example, “reels” may be spun under the control of, for example, a random number generator and when the “reels” are matched in a predetermined pattern the user may be awarded with a particular chit, which may be indicated as an image in the indicia on the “reels.” In this regard, at least some of the indicia may include images that represent products or services.

Further, the spinning of the virtual reels may stop at a timing controlled by the E-Aggregator system, or in response to the user pressing a button. In the latter case, it may be preferable that the timing at which the user presses the button have no effect on the outcome of the award.

After the command signal is received from the user's computer, an outcome is determined from among a number of possible outcomes (Step 4100). The outcome may be selected by, for example, using a random or pseudo-random process to select from among a number of possible outcomes and in accordance with predetermined probabilities or likelihoods of the possible outcomes. For example, if a certain possible outcome has a likelihood of occurrence of 10%, the random process may operate such that there is a 10% chance that the certain possible outcome will be the result of the random process. The types of outcomes and their likelihood of occurrence may be determined by reference to the outcome database.

The random process may be constrained so that no more than one chit (e.g., no more than one free product) may be awarded. Alternatively, more than one chit may be awarded. Further, there may be established a certain likelihood that all of the selected chits for the transaction may be awarded.

Alternatively, the outcome may be selected by, for example, by applying rules based on the user's profile. In this regard, a likelihood of awarding a 50% discount on a given product may be adjusted according to, e.g., the user's historical behavior in not purchasing the given product. Other rules may be applied to vary the likelihood of particular types of outcomes based on factors such as the identity of the user (e.g., whether the user is a new customer or a preferred customer) or the availability of inventory to support awarding of a particular product or service. This information may be tracked, for example, via the incentive tally database.

Additionally, the outcome may also be selected based on a weighting of the value of a particular chit. That is, the likelihood that the particular chit may be awarded may depend on such factors as, for example, the value of the chit. For example, a provider may generally prefer a very low likelihood of awarding a valuable chit such as a large cash prize or a free car. From the point of view of the provider, it may be desirable that any possible large prize have a small likelihood of occurrence and only be available during on-site solicitations, thereby capitalizing on the resultant buzz around such a large prize.

Once the particular outcome has been selected, the resultant chit(s) is awarded to the user and a record of the award may be stored in the user's profile (Step 4110). Further, a message may be generated and sent to the user notifying the user of the award of the chit(s) and providing detailed instruction on how to redeem the chit(s) (Step 4120). At substantially the same time, a message may be generated and sent to the particular provider associated with the awarded chit(s) to notify the provider of the award and the details of the instructions provided to the user (Step 4130).

Alternatively, once a type of outcome has been determined, it may be necessary to select a particular outcome of the determined outcome. For example, if a chit such as a free product is to be awarded, certain rules may be applied to select one of the products chosen for purchase by the user. Instances of such rules have been mentioned above, and may include purely random selection of one of the products, or random selection with the likelihood of selection inversely proportional to the cost of the item. Similar approaches may be taken to selecting a chit such as a product for a 50% discount, if that type of outcome is determined.

If the type of outcome is determined to be an award of a chit such as an up sell or a coupon, rules may be applied to select a particular up sell or coupon to be awarded. Such rules may be stored in suitable databases, such as the up sell outcome database or the chit database. The rules that may be prescribed by providers (or potential sponsors) of such offers, and may depend on whether the providers have paid to sponsor such offers, may be applicable here. The relative likelihood that a particular chit such as an up sell or coupon may be awarded may depend on the relative amounts that providers have paid for a sponsorship fee. For example, if a provider A has paid twice as large a sponsorship fee as provider B, then it may be twice as likely that sponsor A's coupons will be awarded as sponsor B's.

Awarding of a particular chit to a certain user may also be contingent on various rules. For example, the game presentation and the random determination of a possible chit award may only be provided to users who purchase more than a certain number of products or services. Further, the game presentation and the random determination discussed above may be limited to users whose purchases total more than a certain value. Still further, the game presentation and the random determination of a chit award may be limited to users who purchase certain products or certain quantities of certain products.

Additionally, the awarding of certain chits may depend on a time of day, a day of the week, a day of the month, etc. For example, the step of offering a certain chit and/or awarding the chit may be limited to certain times of the day when traffic is normally low at a certain provider location, thereby increasing the likelihood of foot traffic and sales at the location for these times.

Still further, the offer and/or award of the chit(s) may be limited to certain users based on historical behavior, such as, e.g. spending habits at a particular provider location, visiting habits at the particular provider location, or the like.

Still further, the offer and/or award of the chit(s) may be limited to those users who have previously indicated, for example, that they wish to be informed of certain types of chits.

If a chit such as a coupon is awarded as a result of the random process, the coupon may be printed out at the location of the user. Alternatively, the coupon may be a virtual coupon that will be automatically redeemed if the user purchases a product covered by the coupon during a subsequent visit to the provider location. Immediate redemption of the coupon or virtual coupon is also contemplated. It is contemplated to employ game presentations other than a virtual slot machine reel in connection with the disclosure.

Such other game presentations may include a virtual car race in which an image carried on the “winning car” indicates the outcome of the random process. For such a game presentation it is also contemplated to provide a user interface to the user to enable the user to control one of the cars in the car race. However, the result of the race may still be controlled by the E-Aggregator system and/or the provider system in order to control the award of the chit to the user.

Another possible game presentation may be a basketball free throw competition in which animated characters compete to throw a basketball into a hoop. The characters may wear images that correspond to various possible outcomes, with the outcome determined by the random process being reflected by the image worn by the successful competitor among the animated characters.

An animated horseshoe competition is another possible game presentation. In addition, other representations may be used, including animated characters who answer trivia questions, three virtual doors presented for selection by the customer, or a spinning wheel like a roulette wheel or a vertically-oriented wheel with prices around the circumference.

The present disclosure also contemplates omitting the game presentation and presenting the outcome of a random process to the remote user by means of a text output. With the system of the present disclosure, providers can make the shopping experience, and particularly time spent at the provider location, more entertaining and enjoyable for users. As a result, an increased number of users may be attracted to provider locations in which the present disclosure is applied.

In addition, because the game presentation and/or the presentation of results of a chit drawing tends to attract users' attention to the display provided at the provider location, it may be desirable to inject advertising content into the display to generate advertising revenue for the proprietor of the provider location and/or the proprietor of the E-Aggregator system.

The system of the disclosure may also be a vehicle for presenting chits and other promotions to users. The advertising content may, but need not be related to products or services that are promoted through the game presentation and the chits or other promotional offers made available through the system of the disclosure.

It has been noted above that the game presentation may be omitted and the outcome of a random process may be presented to the user by other means, such as by printable output. The product images may be displayed in a game presentation or otherwise.

In the examples provided above, random processes to determine whether a chit solicitation is to be awarded are performed on a transaction-by-transaction basis, such that pluralities of locations selected by the remote user are eligible to award chits. Alternatively, a random process to determine whether a chit is to be awarded may be performed each time the user selects a provider location. For example, a random process may be carried out on each occasion when a provider location is viewed remotely, and a game interface such as a virtual slot machine interface may be provided to indicate the outcome of the random process.

The exemplary embodiments described above indicate that the present disclosure may be applied in a supermarket. It is also contemplated to apply the present disclosure in other types of stores, including hardware stores and home centers, clothing stores, drug stores, department stores, fast food restaurants, bars, night clubs and vending machines. The exemplary embodiments may be practiced in, for example, a cable television service provider system, a radio frequency television broadcast system, a computer network system (such as, e.g., the Internet), a mobile telephony system, a telephone system, or any other system capable of facilitating interactive communication between a provider and a user.

In one embodiment of the disclosure as applied to a restaurant, a terminal system may be installed in the kitchen, where cameras capture live content in the form of a chef or restaurateur giving recipes or today's menu in order to attract consumers.

According to an exemplary application, but in no way limiting of the processes and systems disclosed herein, at least two methods of offering incentives to remote users may be provided according to aspects of the disclosure.

For example, one method may include a remote chit solicitation event that may be provided on a web page or a website of a particular provider location and which may be made available as one or more web pages, including, but not limited to, for example, a pre-determined game, a puzzle, a quiz, an assessment, and/or a survey where the remote user elects to participate in exchange for a chit which may be directly redeemable at the particular provider location. Another method may include, for example, a direct passive chit that may be provided in the form of a banner and “click through content”, which may be made available from the particular provider location's web page or website to the remote user as selected provider content viewable as a result of the remote user's visit.

Similarly, the method may include a remote chit solicitation event that may be provided on, for example, an interactive cable television channel, a television broadcast channel, a radio channel, a satellite radio channel, a telephone channel, or the like. The chit solicitation event may be sent as (or a part of) a communication signal sent from a particular provider location to one or more users. The communication signal may include, but is not limited to, for example, a pre-determined game, a puzzle, a quiz, an assessment, and/or a survey where a user may elect to interactively participate in the solicitation event in exchange for a chit which may be directly redeemable at the particular provider location. The method may include, for example, a direct passive chit that may be provided in the fonr of a banner and a “click through content”, which may be made available from the particular provider location as a part of the communication signal as a result of the user's visit to the provider's location.

According to the exemplary non-limiting application, the provider location may provide a set of requirements to an E-Aggregator system during, for example, subscription account setup. The requirements may be used in a formula for establishing customized direct passive chit solicitations to specific remote users depending on a level of interest that the provider location may have in attracting that type of remote user or users of specific product types into their location. Under these circumstances, once the E-Aggregator system processes the information for the provider location's subscription account, the server system 160 may determine chit solicitations for each individual user.

Accordingly, with a list of chit solicitations that may be attractive to one or more users and a list of chit solicitations which different provider locations are willing to provide, the server system 160 may evaluate each provider location and identify each location with its respective chit solicitations to an interested user, correlating the identification of the chit solicitations to the chit solicitations attractive to the user. Thereafter, the user may be permitted to select a provider location best satisfying the user's needs.

In return for providing chit solicitations to the user, the provider location may receive one or more of the following chit solicitations: an assurance that this specific user will be visiting their location; personal information on the user and a product or service that the user intends to pick up or return; a direct marketing and/or advertising opportunity; an opportunity for the provider location to contact the user by, for example, e-mail or any other advertising mechanism used for marketing purposes, where the contact is limited by restrictions mutually agreed upon between the user and the E-Aggregator system; an opportunity to cross-sell to the user since the primary product has already been identified; and a commitment on behalf of the user to purchase a product or service in the provider location at a minimum cost to offset the chit solicitation provided by the provider location to the user. Any cost that may be associated with this program may include, for example, the setup and administrative costs of the provider location in making arrangements to act as a pick up/delivery center or a cost associated with shipping a product to a remote location.

A particular implementation of the at least two methods of offering incentives to remote consumers may include, for example, a user searching for brand locations within a desired radius of a user provided zip code.

For example, a user may provide a zip code for an area of interest. Once provided, the zip code may be compared to be matched against a database of brand location zip codes. The brand location zip codes may be either complete zip codes or the beginning portions of one or more zip codes.

If comparison match fails, the remote user may be returned to reenter the desired zip code. If the comparison match is acceptable, and a matching zip code is found in the brand location zip codes, the user may be prompted to select a desired radius of within the previously entered zip code. In this regard, a box may be provided with possible radius selections on, for example, a web page that is displayed on the user's computer, prompting the user to accept the desired radius selection. Once provided, the selection may be entered into an algorithm configured to select all subscribing markets located within the desired radius of the provided zip code.

Next, the user may be prompted to select a desired market of shopping interest on a web page within a pre-defined selection box displayed on the user's computer. Once provided, the selection may be entered into an algorithm for selecting all brand locations within the market of shopping interest within the desired radius of the provided zip.

The preferred retail brands may be displayed for selection by the remote user on a web page displayed on the user's computer. The user may then select one brand for which possible provider locations may be displayed. The selection may be entered into an algorithm for selecting all provider locations associated with the selection. The provider locations may be displayed for selection by remote consumer on a web page displayed on the user's computer. The user may then select one of the provider locations for which the user desires to receive streaming content.

A connection may be negotiated between the user's computer and the provider's computer at the provider location selected for “live” content. However, if the connection is unavailable, or the computers are unable to connect, the user's computer may be connected and provided with stored content for the selected provider location on the server system 160.

The server system 160 may use the database system 150 to match one or more direct passive chit to the remote user during content viewing (shown, e.g., in FIG. 1). The provider location's matching media content may be displayed on the user's computer as, for example, a web page.

The matching brands and provider locations may be sent to and displayed on the user's computer using, for example, MPEG, JPEG, or any other compression and/or signal-formatting format technology as the skilled artisan will readily appreciate, without departing from the scope and/or spirit of the disclosure.

Further, the skilled artisan will also appreciate that some brands only have one location, voiding the need for location selection.

According to a further aspect of the exemplary, non-limiting application of the disclosure, a remote user watching the content from a selected provider location may be presented with various chit events for an immediate reward. If the remote user elects to participate in a remote solicitation event of various designs and wins a chit, the chit may be made available for immediate reproduction or printing within the location of the remote user and redemption at the provider location sponsoring the content.

The exemplary methods may provide chit solicitations to each of the parties involved. For example, the exemplary methods may provide a provider having “bricks and mortar” locations, which has the desire to make the Internet a “business builder”, with an opportunity to bring in local e-commerce users to the provider's location. The users may be persons who normally may not visit the provider's location or would not normally visit the provider's location at that time. In this regard, this provides an opportunity for the provider where none previously existed. Additionally, this may provide at-location floor traffic at the provider's location from users seeking to redeem chits or on-location solicitation events and the opportunity to build store loyalty and repeat visits with regular users.

Regardless of whether specific user data is available, the exemplary methods provide the provider with a highly targeted marketing opportunity to attract users, including new and repeat users. The exemplary methods may be implemented such that marketing may be directed from the E-Aggregator system 100b directly to the remote, off-site user provider, and/or directly from the provider system 100a to the on-site, on-location user.

Further, the exemplary methods permit a user to determine what chit solicitations are most important to the user in purchasing a product or service, and, as a result, selecting a provider that satisfies all, or most of those desired chit solicitations. For example, at first it may seem that the most important chit solicitation for many users may be convenience of location. However, when a number of provider locations are available and each location is as convenient or nearly as convenient as the other, then other factors may play a bigger role, such as, for example, a particular chit solicitation which a provider location can supply. Furthermore, chit solicitations may be sufficient to induce a user to travel to a less convenient provider location.

Thus, according to an aspect of the disclosure, chits may be provided to users other than, for example, an actual reduction in a cost of a product or service. The methods may also offer other chit solicitations including, but not limited to, for example, permitting a provider location to market related or unrelated products to users prior to, or at the time of, visiting the provider location. These additional chit solicitations may be provided by the provider location and, as a result, the provider location may influence a user to purchase a product or service at one provider location over another provider location.

A provider may appreciate that investing resources in the above exemplary method may be more effective than investing resources in other forms of advertising since the provider location may be able to direct advertising directly to users. The provider location may be guaranteed a visit by a user and the provider may receive information about the user that may be used to influence a purchase at the location by the user. An ability to market to a user that may be guaranteed to come to the provide location is unique to the systems and methods disclosed herein.

It is understood that each provider location 100a may provide criteria to the E-Aggregator system 100b (shown in FIG. 1), during or after subscription account setup, that may be used as weighting information for each of the many variables associated with, but not limited to, a value of attracting and marketing to a particular user. The E-Aggregator system 100b may assign a weight to the direct passive chit solicitations sought by the user and the chit solicitations sought by the provider locations. Using, for example, predetermined logic, one or more retail locations may be selectively identified to a user based upon an evaluation of these weights.

Using these exemplary methods, it may be possible for a provider location 100a to be strongly suggested to a user based upon a user's profile information and not just the chit solicitations received by the user. The provider location may be presented to the user in a manner influenced by these weighing criteria. The mathematical algorithm for storing and processing the data for these methods may be preferably performed utilizing the server system 160 software (shown in FIG. 1), in which data will be entered, processed and analyzed to produce a list of recommended retail locations for selection by the remote user.

It should be appreciated that any number of factors may be evaluated by a provider location to determine an incentive solicitation that a provider location may be willing to provide to a user. These factors may include, but are not limited to, for example, a location of the user; a location of the participating provider location; an actual cost of the chit: an approximate time expiration of the chit; a purchasing history and other background information for the user; and an identity of the supplier of the product made available by the chit.

Further, it should also be appreciated that any number of chit solicitations may be evaluated by the user to determine the chit solicitation the user may be willing to receive. These chit solicitations may include, but are not limited to, for example, an exact amount of an on-location purchase that may be obtained in lieu of redeeming a chit; a chit such as a free product or service; an in-store credit or discount; a location of the provider location; and an experience of the user and the experiences of other users (which may be summarized in a rating system) with a particular provider location.

To assist the user in selecting a provider location, data may be presented in an organized manner. An individual user may be able to sort and display available provider locations graphically and in tabular form, such as on a computer screen, by location, distance, time of “live” solicitation events, type of provider, experience ratings, and other combinations of criteria and chit solicitations. Furthermore, on-location chits may be in the form of product coupons for use in the provider location.

As discussed, it may be entirely possible for a provider location to provide a weighting criteria to an E-Aggregator system 100b (see FIG. 1). Such a weighing criteria may be applicable to each one of a number of variables including, but not limited to, for example, a desire to attract a user from outside of a normal drawing area for a particular provider location; a desire to attract a user of a primary product, or a desire to attract such a user for any number of different reasons. As a result, the chit solicitations provided to the user by a provider location may be entirely dependent upon the desire of that provider location to draw the user to their location. Therefore, one user may receive completely different chit solicitations than another user visiting the same provider location. Using such a user sensitive arrangement, it is possible to customize chit solicitations to each user to reflect the provider location's desire to have that user visit their location.

According to an aspect of the disclosure, a unique chit may be determined for each provider location transaction using an algorithm based upon weighing factors supplied by participating providers. For example, one chit may be to offer cash-back in the form of on-location credit paid for by the participating provider in exchange for an on-location purchase. In the event that other chits are offered, adjustments may be made to the algorithm.

The algorithm may include at least six transaction variables, including, but not limited to, for example, a user name, a product or service, a provider location, a user location, a time, and a supplier identity.

The user's name may be provided to the provider location. This variable will allow a provider to match the user with the provider's own database of users. Some providers may choose a lesser chit for existing users on the theory that they need not make a special effort to attract that user. Others may see not only the chit solicitation of rewarding loyal users, but more importantly, the chit solicitation of combining an existing database of user specific data with the database provided by the E-Aggregator system to direct marketing to a particular user when prior knowledge is available regarding a certainty of an in-person visit by the user at a particular location. Of course, if a user develops a history of only coming to a store when redeeming a chit and only purchasing low margin or loss leader products, the provider will be able to identify that user and reduce the chit offered to him by adjusting the chit variable.

According to a further aspect of the disclosure, product identification may be used in two ways. First, product identification may be used as a weighing factor as one of the transaction variables. Accordingly, participating provider may find that it is more desirable to attract users of certain products to particular stores. Conversely, some providers may want to reduce or eliminate chit to users purchasing products which compete with the provider's own merchandise. In such a case, the provider may be given an option of not participating as a “package site” for that product or service.

Secondly, product or service identification may be used by the participating provider to identify cross selling products or services for promotion to users. A store Location may be provided as a variable for adjusting chit based upon individual stores. Therefore, a new store, or a store in a market share battle with a new competitor, may be identified as offering greater chits. On the contrary, a provider location which is maximizing its potential may be identified for less than the provider-wide norm of chits.

Further, user location may be used by participating providers in conjunction with an individual provider location. For example, the participating provider may choose to offer an increased chit if the user's home is located in a different zip code or more than a predetermined distance from a particular provider location. The system may permit providers to choose specific zip codes for determining greater, or lesser, chits. The variable time may be expected to be a significant factor. This variable may allow a participating provider to adjust its level of chit solicitations based on the season and/or specific chit expirations.

Further, the identity of a supplier may be required by some participating providers so that they can “lock out” participation as a package for products or services from competitors. Because of the great number of variations which can occur with a number of product categories, a large number of provider locations, and a large number of user location possibilities, it may be anticipated that each participating provider may have a company wide set of basic criteria and only occasionally make changes for particular locations. The system may allow each participating provider to authorize its provider locations to make changes to the variable weightings for their location. In this regard, password identifiers may be issued to provider locations and providers may be able to establish parameters of discretion for each provider location.

According to an aspect of the disclosure, a highly-focused localized marketing process may be implemented that may increase floor traffic and sales at individual provider locations. For example, scheduled chit solicitation events where a few event participants win chits in exchange for exposure and buzz may be a unique and powerful method for building floor traffic without incurring significant, if any cost to the provider. In its simplest implementation, the chit promoted to a user may be extra-ordinary in that the chit is out of the normal range of chits normally offered to general users. The chit may be offered to everyone and only fairly given to a few, thereby increasing the likelihood of bringing people in the door of a particular provider location. These on-location and remote solicitation events create unique advance direct marketing opportunities.

A provider may appreciate the fact that the chits do not have to be offered equally to all prospects. Thus, since the on-site, on-location extra-ordinary chits may be offered to the masses, but only given to a select few at any given time within the local reach of a particular provider location, the marketing expense may be minimized because of a resultant buzz factor and the marketing the E-Aggregator system may provide. The resultant savings in marketing resources may instead be used to increase and enhance offered on-location chits where the chits are most influential.

According to a further aspect of the disclosure, a method of directing a user to a provider location and providing the provider with a unique, direct marketing system is provided. The method is directed to influencing a user prior to a provider location visit and during the provider location visit by the user. The combination of the floor traffic generation, localized marketing, advertising, customer information, and direct marketing, which are all directed to or concerning a specific user known to be coming to a provider location within a defined time frame, constitutes one aspect of the disclosure.

Additionally, the method of directing a user to a particular provider location provides for an ideal opportunity for cross-selling of products or services. The cross selling of products may include, for example, the activity of promoting a product or service that, when combined with a primary product, makes a better or complete solution. Cross selling may also include the activity of promoting any product or service that a provider location may offer to a user based upon the user's characteristics and user purchase history with regard to similar products.

Additionally, it should be appreciated that communication with user may also be viewed by others in the user's family or household, or other persons sharing an. Internet address or other persons sharing the same individual cable television address. It should also be appreciated that a provider location, in one arrangement, could be a provider location that provides products completely different from the product (primary product) solicited to the user.

The methods provided according to aspects of the disclosure may be useful to third-party advertisers that are unrelated to a provider location. For example, third-party advertisers may be given an opportunity to provide direct marketing to individuals who may be traveling in a known geographic area. In this regard, the advertisers may be located near the provider location. Moreover, manufacturers may be offered an opportunity to advertise products or services sold in provider locations. Accordingly, manufacturers may be able to market to a class of users known to be coming into particular provider locations. Predicting and influencing future behavior of users makes this form of advertising particularly beneficial.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

In accordance with various embodiments of the present disclosure, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

It should be further noted that any communications link between two devices, two systems, or a system and device may include a wire communications media, an optical communications medium, a wireless communications media, or any combination thereof, as the skilled artisan will readily appreciate without departing from the scope and/or spirit of the disclosure.

Although the present specification describes components and functions implemented in the embodiments with reference to particular standards and protocols, the disclosure is not limited to such standards and protocols. Accordingly, replacement standards and protocols having the same functions are considered equivalents.

The disclosure has been described with reference to the preferred embodiments. Obvious modifications and alterations will occur to others upon reading and understanding the preceding detailed description. It is intended that the invention be construed as including all such modifications and alterations insofar as they come within the scope of appended claims or the equivalents thereof.

What is claimed is:

1. A system for a priori providing a user profile of a partaker user to a provider where the partaker user is scheduled to visit a location of the provider, the system comprising:
a receiver configured to receive a multimedia content from the provider;
a determiner configured to determine a chit set corresponding to the multimedia content or the provider;
an aggregator configured to combine the multimedia content and the chit set to generate a streaming content;
a user communicator configured to send the streaming content to the partaker user, the user communicator being further configured to receive a chit selection from the partaker user;
a profiler configured to determine a chit on a basis of the chit selection and a user profile associated with the partaker user; and
a provider communicator configured to send a visit schedule message to the provider.

2. The system according to claim 1, further comprising:
a group assembler configured to receive user data from at least one user responding to a user solicitation event and generate a user group, including the user data; and
a selector configured to select the partaker user from the user group on a basis of the user profile.

3. The system according to claim 1, wherein
the multimedia content comprises at least one of a video content, an audio content, a text content and a control content and
the aggregator is further configured to link the chit set to a portion of the video content, the link being selectable by the user while sensing the streaming content to generate the chit selection.

4. The system according to claim 3, wherein the multimedia content further comprises a chit event and the chit event comprises a live broadcast from the location of the provider.

5. The system according to claim 1, wherein the provider communicator is further configured to send the visit schedule message to another provider, the another provider being located en route from a location of the partaker user to the location of the provider.

6. The system according to claim 1, further comprising a mobile transducer system, the mobile transducer system comprising:
an image pickup device configured to capture an image of an object;
a transducer configured to sense an ambient signal;
a display configured to display a message;
an input-output interface configured to receive data from the user; and
a driver configured to move the mobile transducer system on the basis of a control signal,
wherein the control signal is received from one of a manual control input or a robot control input.

7. The system according to claim 1, wherein the visit schedule message comprises at least one of:
a title of a live broadcast event;
a date and time of the chit event;
a name of the partaker user;
a location of the partaker user;
a route to be traveled by the partaker user;
a telephone number of the partaker user;
the chit selection of the partaker user; or
the user profile of the partaker user.

8. The system according to claim 1, wherein the multimedia content is generated by a mobile transducer system, the mobile transducer system comprising:
a transducer configured to capture an image or a sound generated proximate to the partaker user; and
an input configured to receive data.

9. The system according to claim 1, wherein the user communicator is further configured to send a chit event schedule to the partaker user.

10. A method for a priori providing a user profile of a partaker user to a provider where the partaker user is scheduled to visit a location of the provider, the method comprising:
receiving a multimedia content from the provider;
determining a chit set corresponding to the multimedia content or the provider;
combining the multimedia content and the chit set to generate a streaming content;
sending the streaming content to the partaker user;
receiving a chit selection from the partaker user;
determining a chit on a basis of the chit selection and a user profile associated with the partaker user; and
sending a visit schedule message to the provider.

11. The method according to claim 10, further comprising:
receiving user data from at least one user responding to a user solicitation event to generate a user group, including the user data; and
selecting the partaker user from the user group on a basis of the user profile.

12. The method according to claim 10, wherein the multimedia content comprises at least one of a video content, an audio content, a text content and a control content.

13. The method according to claim 12, wherein the combining comprises linking the chit set to a portion of the video content, the linking being selectable by the user while sensing the streaming content to generate the chit selection.

14. The method according to claim 12, wherein the multimedia content further comprises a chit event and the chit event comprises a live broadcast from the location of the provider.

15. The method according to claim 10, further comprising:
receiving a request from the provider for delivery of a mobile transducer system;
determining a condition for use of the mobile transducer system by the provider; and
delivering the mobile transducer system to the provider.

16. The method according to claim 10, further comprising:
sending the visit schedule message to another provider, said another provider being located en route from a location of the partaker user to the location of the provider; and
sending a chit event schedule to the partaker user.

17. The method according to claim 10, wherein the visit schedule message comprises at least one of:
a title of a live broadcast event;
a date and time of the chit event;
a name of the partaker user;
a location of the partaker user;
a route to be traveled by the partaker user;
a telephone number of the partaker user;
the chit selection of the partaker user; or
the user profile of the partaker user; and
wherein the multimedia content is generated by a mobile transducer system, the mobile transducer system comprising:
a transducer configured to capture an image or a sound generated proximate to the partaker user; and
an input configured to receive data.

18. A computer readable medium including a program that when executed, causes a computer to a priori provide a user profile of a partaker user to a provider where the partaker user is scheduled to visit a location of the provider, the computer readable medium comprising:
a receiver code section configured to cause, when executed, receiving a multimedia content from the provider;
a determiner code section configured to cause, when executed, determining a chit set corresponding to the multimedia content or the provider;
an aggregator code section configured to cause, when executed, combining the multimedia content and the chit set to generate a streaming content;
a user communicator code section configured to cause, when executed, sending the streaming content to the partaker user, the communication being further configured to receive a chit selection from the partaker user;
a profiler code section configured to cause, when executed, determining a chit on a basis of the chit selection and a user profile associated with the partaker user; and
a provider communicator code section configured to cause, when executed, sending a visit schedule message to the provider.

19. The computer readable medium according to claim 18, further comprising:
a group assembler code section configured to cause, when executed, receiving user data from at least one user responding to a user solicitation event and generate a user group, including the user data; and
a selector code section configured to cause, when executed, selecting the partaker user from the user group on a basis of the user profile.

20. The computer readable medium according to claim 18, further comprising:
a request receiving code section configured to cause, when executed, receiving a request from the provider for delivery of a mobile transducer system;
a condition determining code section configured to cause, when executed, determining a condition for use of the mobile transducer system by the provider; and
a delivering code section configured to cause, when executed, delivering the mobile transducer system to the provider.
